(19) United States
(12) Patent Application Publication
(10) Pub. No.: US 2025/0291637 A1
(43) Pub. Date: Sep. 18, 2025

(54) SCALE COMPUTING IN DETERMINISTIC CLOUD ENVIRONMENTS

(71) Applicant: Groq, Inc., Mountain View, CA (US)

(72) Inventors: Evan Daniel Patrick, San Jose, CA (US); Jonathan Alexander Ross, Palo Alto, CA (US)

(21) Appl. No.: 19/221,967

(22) Filed: May 29, 2025

Related U.S. Application Data
(63) Continuation of application No. 18/689,011, filed on Mar. 4, 2024.
(60) Provisional application No. 63/240,632, filed on Sep. 3, 2021.

(51) Int. Cl. G06F 9/50; G06F 8/41; G06F 11/34

(52) U.S. Cl. CPC G06F 9/5038; G06F 8/41; G06F 11/3452

(57) ABSTRACT

A computing system can include a plurality of deterministic processors. Each deterministic processor can be configured to execute one or more assembled programs in a program order of the one or more assembled programs. The computing system can include a plurality of communication links providing communication between pairs of processors of the plurality of deterministic processors.

### CROSS-REFERENCE TO RELATED APPLICATIONS

The subject patent application is a continuation of U.S. Ser. No. 18/689,011, which is a U.S. National Stage filing under 35 U.S.C. § 371 of International Patent Cooperation Treaty (PCT) Application No. PCT/US2022/041907, filed Aug. 29, 2022, and entitled “SCALE COMPUTING IN DETERMINISTIC CLOUD ENVIRONMENTS,” which application claims the benefit of priority to U.S. Provisional Patent Application Ser. No. 63/240,632, filed on Sep. 3, 2021, entitled “Warehouse Scale Computing”, all of which are hereby incorporated by reference in their entireties herein.

This application incorporates by reference in its entirety U.S. patent application Ser. No. 17/203,214, filed on Mar. 16, 2021, which claims the benefit of priority to U.S. Provisional Application Ser. No. 63/114,500, filed 16 Nov. 2020, entitled “Tensor Streaming Processor Architecture”.

### TECHNICAL FIELD

The present disclosure generally relates to a processor architecture, and more specifically to scale computing in deterministic cloud environments.

### BACKGROUND

Deep learning inference is the process of using a trained Deep Neural Networks (DNN) model to make predictions against previously unseen data. DNN inferences have found widespread use due to their versatility and demonstrated value. Despite excellent performance of DNN models, high overhead of computation and memory makes their deployment on the client-end a challenging task, especially for resource limited mobile platforms such as smartphones and wearable devices. Hence, DNN inferences are emerging as a service provided by cloud computing environments for object recognition, intelligent speech, natural language processing, natural language understanding, etc. The DNN inference workloads are becoming increasingly important and widespread in cloud computing environments.

To improve resource efficiency, DNN inference services traditionally use the batching strategy. The batching strategy is widely adopted to effectively improve a throughput of DNN inference as the batching strategy makes better utilization of parallel computing resources that are typically central processing units (CPUs) and graphics processing units (GPUs). The increasing batching can provide an increased throughput, but too much waiting time in a queue can often violate quality of service (QOS) commitments for sub-second latency. Thus, the scheduling for DNN inference must consider batch size selection to satisfy the requirements on both latency and throughput, which is often challenging when the workload demand is bursty and the sub-second latency is required.

The ITU-T G.1080 recommendation proposes a quality of experience (QoE) model that classifies QoE factors into two parts: subjective human components and objective QoS parameters. The QoE model classifies technical QoS parameters as part of the human objective QoE factor. Thus, while the batching strategy may suffice to meet QoS latency requirements, the costs may be prohibitive if the provider needs to also meet QoE expectations of the user. Even if the cloud environment is overprovisioned, the QoE expectations may not be met when workload bursts occur.

### SUMMARY

In recent years, there has been tremendous use in industry of one type of multivariate statistical analysis, commonly referred to as “machine learning” or “artificial neural networks”. At the heart of such analysis techniques is linear algebra, in particular, vector-matrix multiplication. For example, an input vector numerically represents an image (e.g., of a handwritten character), and the matrix numerically encodes the trained weights of a multilevel artificial neural network. The input vector and matrix are multiplied to produce an output vector. Certain elements of the output vector can have large values, indicating that the image encoded in the input vector belongs to a certain class of images.

When the size of the input vector is large (e.g., 1024 elements) to represent in great detail (or with many characteristics) some class of data objects (e.g., images, or time series data from the futures market), the training matrix can be of the size of, e.g., 1024 by 1024 elements. Multiplying the input vector by the training matrix can require over 1 billion multiplications and additions. Training a matrix with tens of thousands of sample vectors thus requires hundreds of trillions of multiplications and additions. Such multiplications and additions, when executed on a computer are manipulated in the form of floating-point operations (“FLOPS”), with a trillion FLOPS referred to as a teraflop.

This demand for performing huge numbers of vector-matrix multiplications has led to the development of specialized processors that can perform many teraflops and petaflops per second, to meet the real-time needs of those in industry using this statistical analysis technology. One family of such specialized processors are referred to as “streaming processors.” With streaming processors, the linear algebra operations are partitioned into streams of data and/or instructions on a host processor, and then sent to the specialized processors to be acted upon as quickly as possible. For example, a vector-matrix multiply can be executed by partitioning the matrix into a set of row vectors, and then creating a stream. This entire stream can be then sent to the specialized processor (or first the stream is created inside the host processor for use on the streaming processor with large amounts of internal memory), after which the streaming processor executes the necessary mathematical operations to enable the linear algebra calculations, such as the vector-matrix multiply operation.

An example of a streaming processor is a Tensor Streaming Processor (TSP), developed and manufactured by GROQ, INC. of Mountain View, California. For use in commerce, the GROQ TSP Node™ Accelerator Card is available as a x16 PCI-Express (PCIe) 2-slot expansion card that hosts a single GROQ Chip1™ device. The TSP is a streaming processor based on two key optimizations: (1) machine learning algorithms exhibit abundant data parallelism, which are directly mapped to the scalable architecture, and (2) the scalable architecture enables precise planning for and control of the architecture by compilers, thus greatly increasing performance and power efficiency. Tensor computations (typically computations on vectors and matrices) are performed using a streaming process model where computational tiles, and data storage and switching tiles, are interconnected for data transfers between tiles by a superlane structure. The superlane structure takes advantage of dataflow locality as elements of tensors flow through the architecture to be calculated upon. The TSP architecture is disclosed in more detail in U.S. patent application Ser. No. 17/203,214 which was filed 16 Mar. 2021, incorporated herein in its entirety.

One strength of streaming processors is that there are no disruptions in the processing flow, similar to a pipeline operation. The data and/or instructions flow in specified directions, and each processing sub-section of the streaming processor only needs to 1) accept data, 2) process the data, and then 3) pass the data and results to the next sub-section. Structuring the data, assembling the final results, and scheduling the data flows typically is not executed by the processing sub-sections, but handled by other sub-sections of the streaming processor or by a host computer connected to the streaming processor. The streaming processor halts execution when all of the data is processed.

Embodiments of the present disclosure are directed to a deterministic streaming system with one or more deterministic streaming processors (e.g., TSPs or artificial intelligence processors) each having a functional slice architecture. In some embodiments, each deterministic streaming processor is configured to process a machine learning (ML) model. Each deterministic streaming processor is divided into a plurality of functional units organized into a plurality of functional slices. Each functional slice is configured to perform specific functions within the deterministic streaming processor, which can include memory functional slices (MEMs) for storing operand data, arithmetic functional slices for performing operations on received operand data (e.g., vector processing, matrix manipulation), and/or the like. Functional units of the deterministic streaming processor are configured to stream operand data across a first (e.g., temporal) dimension in a direction indicated in a corresponding instruction, and receive instructions across a second (e.g., spatial) dimension. The compiler for the deterministic streaming processor is aware of the hardware configuration of the deterministic streaming processor, and configures the timing of data and instruction flows such that corresponding data and instructions are intersected at each computational element at a predetermined time. Each functional slice of the deterministic streaming processor can operate on a set of data lanes in a Single Instruction Multiple Data (SIMD) manner. The set of data lanes can be referred to herein as a “superlane” and represents a cross-section of all the functional slices on a processor chip.

The TSP architecture is deterministic, and the memory accesses are therefore deterministic as well. Given the unprecedented compute density enabled by the TSP architecture, for the requisite operational intensity of the ML models, the TSP's architecture also supports unprecedented memory bandwidth. As a single core architecture, the TSP device supports an extremely high bandwidth, chip-wide data path that allows all compute elements in the chip to have access to a global memory space directly without a cache hierarchy.

The TSP is uniquely positioned to enable use of dynamic random-access memory (DRAM), magneto-resistive random-access memory (MRAM), NOR flash memory, etc. as near-compute memory to directly compute from without a cache hierarchy. Given the simple requirements of the TSP memory access, by using DRAM as near-compute memory, the TSP architecture enables simplification of the DRAM architecture while improving bandwidth, concurrency, power and per-bit cost for DRAM over existing DRAM architectures.

The TSP has significantly higher computer density, for example, approximately seven times better compute density per transistor, and significantly improved memory bandwidth compared to the dominant commercially available graphics processing unit (GPU) incumbent. Balancing memory capacity for such large tasks with high compute density such as that of the TSP's architecture suggests the use of high-density memories such as DRAM as a preferred compute memory.

The TSP architecture being deterministic uniquely allows for use of memories such as DRAM (and even slow non-volatile memory (NVM) such as MRAM, NOR flash memory, etc.) that are much slower in random access but do enable extremely high density per device at much lower bit cost to be used as near-compute memory. This coupled with the TSP architecture's high bandwidth global data path mated with stacking technologies allows for coupling the high-density memories (like DRAM) directly to the compute units in the TSP single core. The result is an extremely high-density compute engine coupled to an extremely high density near-compute memory with an extremely high bandwidth data path enabling a device that is balanced in compute density, memory bandwidth and memory density. This allows for use of a significantly smaller number of devices for large tasks resulting in a significantly lower accessory (like host processors, storage, networking, power subsystems etc.) usage and correspondingly lower energy consumption.

Because many modern high-performance reduced instruction set computer (RISC), complex instruction set computer (CISC) and GPU architectures are not deterministic, they cannot directly use DRAM because the effective random transaction rate (RTR) is too slow (e.g., approximately 25M RTR/s corresponding to Row Cycle Time (tRC) of 40 ns)—these architectures require a cache hierarchy wherein the caches provide the RTR required. Also, because these competing architectures use a large number of cores and do not have a high bandwidth global data path like the TSP, they cannot use high bandwidth stacking techniques to access DRAM as a global addressable space. Global data path means that the switching network is substantially exclusively located on the processor die. Global addressable space means that each memory address is globally accessible to the processor independent of which bank the data is stored. Thus, the prior art RISC, CISC and GPU architectures can use only a set of banks for each core but not as global memory. Also, because the prior art DRAM RTR is too low, DRAM banks cannot be used as a local cache in the hierarchy.

Embodiments of the present disclosure are directed to methods and system architectures for meeting demanding quality of experience (QoE) requirements for Deep Neural Network (DNN) inferences, provided as services in cloud computing environments for, e.g., object recognition, intelligent speech, natural language processing, natural language understanding, Long Short Term Memory, and similar inference workloads. The TSP is well suited for handling DNN inference workloads in cloud computing environments because the TSP maintains a batch size of one, thereby meeting even the most stringent quality of service (QOS) requirements. However, meeting QoS requirements for a single workload is not the only requirement. With the TSP having a batch size of one, no queuing is required before tasks are run. Furthermore, because execution of the compiled model is precisely known, it is possible to accurately align cloud computing resources with actual workloads (independent of how bursty the workloads are), and still meet QoE requirements.

Embodiments of the present disclosure are directed to a deterministic streaming system (e.g., TSP system) deployed in a cloud computing environment. The deterministic streaming system includes a scheduler, and a plurality of deterministic streaming processors, each deterministic streaming processor including an array of processing elements. The scheduler evaluates a latency for each task of a plurality of tasks to be run at the deterministic streaming system. The scheduler then adjusts at least one of an accuracy metric and a quality metric for an output of each of the plurality of tasks based on the evaluated latency until the plurality of tasks can be completed before expiration of one or more contractual deadlines. At least a subset of the plurality of deterministic streaming processors is configured to run the plurality of tasks each having the output with at least one of the adjusted accuracy metric and the adjusted quality metric.

Embodiments of the present disclosure are further directed to a method of deterministic computing at a deterministic streaming system (e.g., TSP system) deployed in a cloud computing environment, the method comprising: evaluating, by a scheduler of the deterministic streaming system, a latency for each task of a plurality of tasks to be run at the deterministic streaming system; adjusting, by the scheduler, at least one of an accuracy metric and a quality metric for an output of each of the plurality of tasks based on the evaluated latency until the plurality of tasks can be completed before expiration of one or more contractual deadlines; and running, by at least a subset of the plurality of deterministic streaming processors of the deterministic streaming system, the plurality of tasks each having the output with at least one of the adjusted accuracy metric and the adjusted quality metric.

Embodiments of the present disclosure are further directed to a non-transitory computer-readable storage medium comprising stored thereon executable instructions, which when executed by at least one computer processor of a deterministic streaming system cause the at least one computer processor to: evaluate, by a scheduler of a deterministic streaming system, a latency for each task of a plurality of tasks to be run at the deterministic streaming system; adjust, by the scheduler, at least one of an accuracy metric and a quality metric for an output of each of the plurality of tasks based on the evaluated latency until the plurality of tasks can be completed before expiration of one or more contractual deadlines; and run, by at least a subset of the plurality of deterministic streaming processors of the deterministic streaming system, the plurality of tasks each having the output with at least one of the adjusted accuracy metric and the adjusted quality metric.

Embodiments of the present disclosure are further directed to a system for executing a plurality of tasks at a processor farm, the system comprising a scheduler that is configured to: achieve a level of confidence for a first task of the plurality of tasks in a queue to generate a result having an accuracy metric above a threshold accuracy, adjust a level of accuracy of one or more other tasks of the plurality of tasks in the queue to increase a quality metric of the one or more other tasks, based on deterministic information about an amount of computation that can be performed at the processor farm within a defined time period, and adjust, based on the deterministic information, at least one of an accuracy metric and a quality metric of results generated by the plurality of tasks until the plurality of tasks can be completed by defined contractual deadlines.

### BRIEF DESCRIPTION OF THE DRAWINGS

Figure (FIG. 1A illustrates an arrangement of functional slices in a tensor streaming processor (TSP), in accordance with some embodiments.

FIG. 1B illustrates an example TSP architecture, in accordance with some embodiments.

FIG. 1C illustrates organization and data flow within a row of a TSP, in accordance with some embodiments.

FIG. 2 depicts stream registers of a TSP that are numbered to show their locations between functional slices within a superlane, in accordance with some embodiments.

FIG. 3 illustrates a die photo of an ASIC implementation of a TSP, in accordance with some embodiments.

FIG. 4A illustrates an example serverless deterministic cloud system having a plurality of TSP processors for managing execution of various models, in accordance with some embodiments.

FIG. 4B illustrates an example process of compiling a model for the deterministic cloud system in FIG. 4A based on partial compilation and model variation, in accordance with some embodiments.

FIG. 5 is a flowchart illustrating a method of deterministic computing at a deterministic streaming system, in accordance with some embodiments.

FIG. 6A is an example abstract diagram of a computer system suitable for enabling embodiments of the claimed disclosures for use in commerce, in accordance with some embodiments.

FIG. 6B is another abstract diagram of a computer system suitable for enabling embodiments of the claimed disclosures for use in commerce, in accordance with some embodiments.

FIG. 7 illustrates a computing machine for use in commerce, in accordance with some embodiments.

The figures depict embodiments of the present disclosure for purposes of illustration only. One skilled in the art will readily recognize from the following description that alternative embodiments of the structures and methods illustrated herein can be employed without departing from the principles, or benefits touted, of the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that can be employed without departing from the principles of what is claimed.

Reference will now be made in detail to several embodiments, examples of which are illustrated in the accompanying figures. It is noted that wherever practicable similar or like reference numbers can be used in the figures and can indicate similar or like functionality. The figures depict embodiments of the disclosed system (or method) for purposes of illustration only. One skilled in the art will readily recognize from the following description that alternative embodiments of the structures and methods illustrated herein can be employed without departing from the principles described herein.

### Overview

Disclosed are configurations that include a deterministic streaming system with one or more deterministic streaming processors (e.g., tensor streaming processors (TSPs) or artificial intelligence processors). Each deterministic streaming processor has a functional slice architecture. In some embodiments, each deterministic streaming processor is configured to process a machine learning model. Each deterministic streaming processor can be divided into a plurality of functional units. The functional units are organized into a plurality of functional slices. Each functional slice is configured to perform specific functions within the deterministic streaming processor. The deterministic streaming processor includes memory functional slices (MEMs) for storing operand data, arithmetic functional slices for performing operations on received operand data (e.g., vector processing, matrix manipulation), and/or the like. Functional units of the deterministic streaming processor are configured to stream operand data across a first (e.g., temporal) dimension in a direction indicated in a corresponding instruction, and receive instructions across a second (e.g., spatial) dimension. The compiler for the deterministic streaming processor is aware of the hardware configuration of the deterministic streaming processor, and can configure the timing of data and instruction flows such that corresponding data and instructions are intersected at each computational element at a predetermined time. Each functional slice of the deterministic streaming processor can operate on a set of data lanes in a Single Instruction Multiple Data (SIMD) manner. The set of data lanes can be referred to herein as a “superlane” and represents a cross-section of all the functional slices on a processor chip.

The disclosed embodiments are directed to one or more deterministic streaming processors each having a functional slicing architecture. In some embodiments, each deterministic streaming processor comprises a tensor streaming processor (TSP) having a functional slicing architecture, which can be used for hardware-accelerated machine learning (ML) applications.

The deterministic streaming processor (e.g., TSP) comprises a plurality of “computational elements,” each computational element corresponding to a functional unit within the deterministic streaming processor. The on-chip memory and network-on-chip (NoC) of the deterministic streaming processor architecture can be fused to provide both storage of operands and results, and can act as a conduit for transferring operand and/or result data to/from the functional units of the deterministic streaming processor. The computational elements of the deterministic streaming processor can be divided between different functionalities (e.g., memory, arithmetic operation, etc.), and can be organized as functional slices which operate on multi-dimensional data (e.g., tensors). For example, each functional slice is composed from computational elements which border (or abut) each other, both horizontal and vertically, to form the functional slice. The number of computational elements and computation granularity of each computational element can be selected to take advantage of the underlying technology on which it is built. Taken together, the number of computational elements (N) and the word granularity (M) of a memory (e.g., static random-access memory (SRAM)) yields the vector length (VL) of the machine.

In some embodiments, each functional slice of the deterministic streaming processor functions independently, and receives instructions from an instruction control unit (ICU). The ICU can pass instructions to a first computational element of the functional slice, which can be then propagated in a first temporal dimension of the deterministic streaming processor along the functional slice to the remaining computational elements of the functional slice. On the other hand, data operands for storage and/or processing can be passed between different functional slices of the deterministic streaming processor, in a second spatial dimension of the deterministic streaming processor perpendicular to the first temporal dimension. As such, the data flow and the instruction flow of the deterministic streaming processor are separate flows.

In some embodiments, a compiler for the deterministic streaming processor is aware of the hardware configuration of the deterministic streaming processor, and synchronizes the timing of data and instruction flows such that corresponding data and instructions are received at each computational element with a predetermined temporal relationship (e.g., during the same clock cycle, separated by a predetermined delay, etc.). In some embodiments, the predetermined temporal relationship is based upon the hardware of the deterministic streaming processor, a type of instruction, and/or the like. Because the temporal relationship between data and instructions are known by the compiler, the operand data received by a computational element does not include any metadata indicating what the data is to be used for or where the data is to be consumed. Instead, each computational element receives instructions, and based upon the predetermined timing, performs the instruction on the current data held by a register associated with the computational element. This allows for the data and instructions to flow through the deterministic streaming processor more efficiently.

Embodiments of the present disclosure are directed to methods and system architectures for meeting demanding quality of experience (QoE) requirements for Deep Neural Network (DNN) inferences, provided as services in cloud computing environments for, e.g., object recognition, intelligent speech, natural language processing, natural language understanding, Long Short-Term Memory (LSTM) and similar inference workloads. The TSP is well suited for handling DNN inference workloads in cloud computing environments because the TSP maintains a batch size of one, thereby meeting even the most stringent quality of service (QOS) requirements. However, meeting QoS requirements for a single workload is not the only requirement. With the TSP having a batch size of one, no queuing is required before tasks are run. Furthermore, because execution of the compiled model is precisely known, it is possible to accurately align cloud computing resources with actual workloads (independent of how bursty the workloads are), and still meet QoE requirements.

Embodiments of the present disclosure are directed to a deterministic streaming system (e.g., TSP system) deployed in a cloud computing environment. The deterministic streaming system includes a scheduler, and a plurality of deterministic streaming processors, each deterministic streaming processor including an array of processing elements. The scheduler evaluates a latency for each task of a plurality of tasks to be run at the deterministic streaming system. The scheduler then adjusts at least one of an accuracy metric and a quality metric for an output of each of the plurality of tasks based on the evaluated latency until the plurality of tasks can be completed before one or more contractual deadlines expire. At least a subset of the plurality of deterministic streaming processors is configured to run the plurality of tasks each having the output with at least one of the adjusted accuracy metric and the adjusted quality metric.

### Architectural Overview of Tensor Streaming Processor

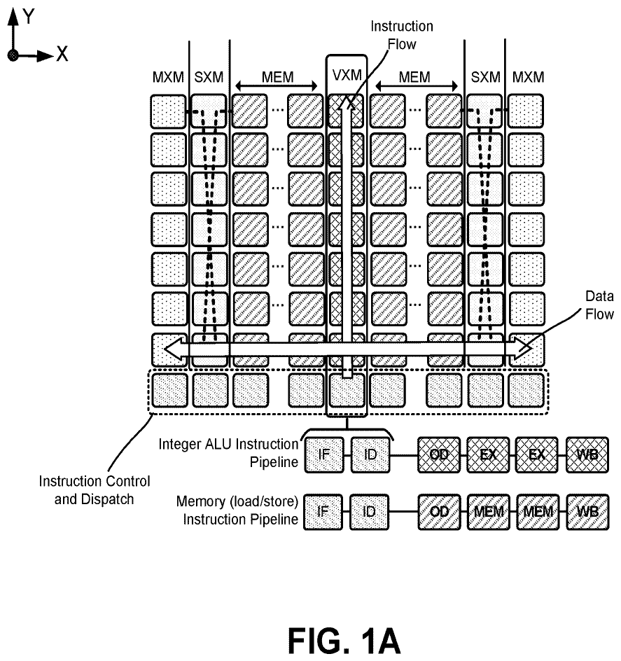

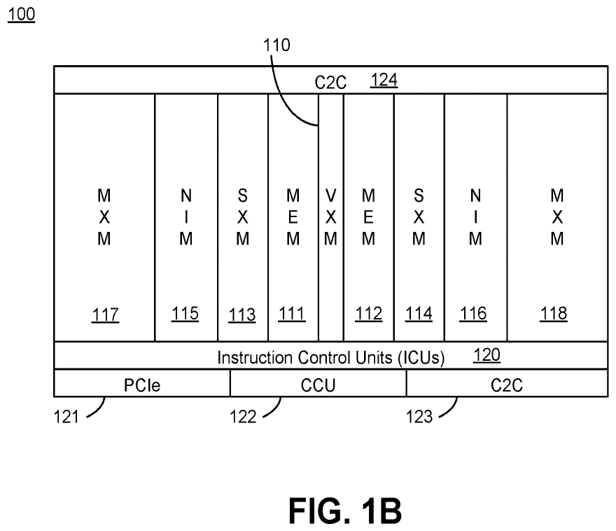

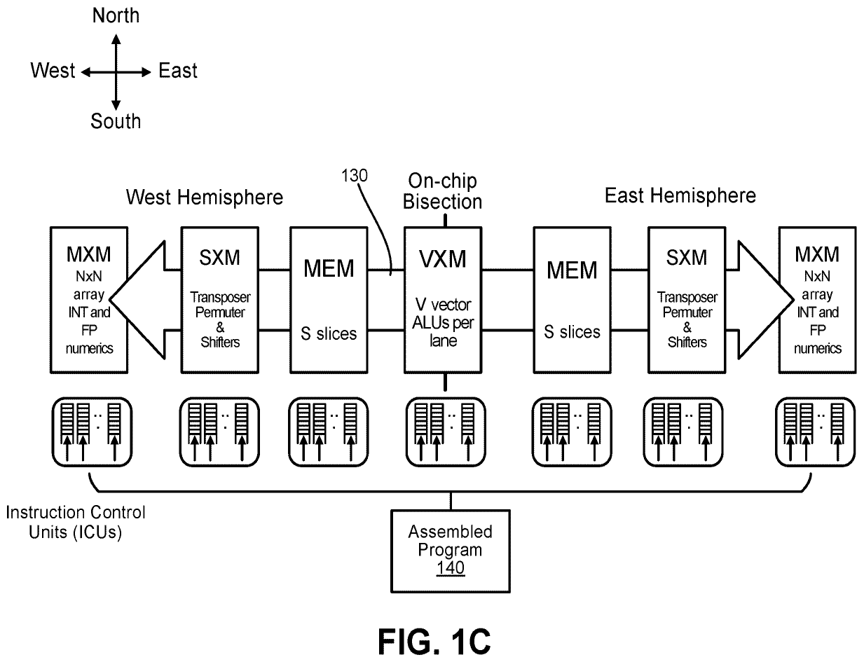

In accordance with embodiments of the present disclosure, the deterministic streaming processor plane comprises a TSP, e.g., as is commercially available from GROQ, INC. of Mountain View, California. It is to be understood that although many embodiments described herein use a TSP as the preferred deterministic streaming processors, other deterministic streaming processors can be used in commercial applications. Figure (FIG. 1A shows an arrangement of functional slices in a TSP, in accordance with some embodiments.

Certain core architectural elements set the TSP apart from GPU and accelerators. In a conventional chip multiprocessor (CMP), each “computational element” is an independent core that is interconnected using the on-chip network to exchange data between cores. Instruction execution is carried out over several stages: (i) instruction fetch (IF), (ii) instruction decode (ID), (iii) execution (EX) on Arithmetic Logic Units (ALUs), (iv) memory access (MEM), and (v) writeback (WB) to update the results in the general-purpose registers (GPRs).

In contrast from conventional multicore, where each computational element is a heterogeneous collection of functional units but globally homogeneous, the TSP inverts that to have a local functional homogeneity but chip-wide (global) heterogeneity. More specifically, the TSP reorganizes the homogeneous two-dimensional mesh of cores into the functionally sliced microarchitecture shown in FIG. 1A. In this approach, each computational element implements a specific function and is stacked vertically into a specific “functional slice” in one dimension (e.g., the Y-dimension) of the two-dimensional on-chip mesh. The TSP disaggregates the basic elements of the conventional multicore per their respective functions: instruction control and dispatch (e.g., via instruction control unit (ICU)), memory (MEM), integer (INT) arithmetic, floating point unit (FPU) arithmetic, and network (NET) interface. Each row of the two-dimensional on-chip mesh contains a cross section of all functional slices.

In this organization, each functional slice is independently controlled by a sequence of instructions specific to its on-chip role. For instance, the MEM functional slices support Read and Write but not, necessarily Add or Mul, which are typically performed in arithmetic functional slices (e.g., the vector execution module (VXM) and matrix execution module (MXM) functional slices) for some typical machine learning (ML) algorithms, such as the linear regression algorithm.

All functional slice's computational elements execute the same instruction stream—Single Instruction Multiple Data (SIMD) instructions. Thus, the common instruction decode and dispatch logic can be factored out into its own computational element (e.g., ICU) and decompose the normal instruction execution pipeline into two areas: (i) instruction fetch, decode, and parceling; and (ii) operand read, execute, and writeback. This approach decouples the memory subsystem from the functional units retrieving their operands and depositing results.

In some embodiments, each functional slice implements, e.g., a 20-stage vector pipeline that spans the computational elements of each functional slice, with each computational element producing 16 elements of the 320-element maximum vector length. This organization naturally decomposes instruction flow in the vertical dimension, and data flow in the horizontal dimension as the data flow passes over different function types. With this processor organization, instruction execution is carried out by different computational elements: instruction fetching and decoding in the ICU and operand decode, execution and writeback at each computational element of the functional slice as the (vertical flowing) dispatched instruction intersects with the (horizontal flowing) operand data on which the dispatched instruction is operating. It will be appreciated that reference to ‘vertical’ and ‘horizontal’ or ‘north’, ‘south’, ‘east’ and ‘west’ are used in connection with the illustrations shown in the Figures, are abstractions that are solely intended to aid the reader and should not be inferred as technical limitations.

FIG. 1B illustrates an example TSP 100, in accordance with some embodiments. The TSP 100 includes memory and arithmetic units optimized for multiplying and adding input data with weight sets (e.g., trained or being trained) for machine learning applications (e.g., training or inference). For example, the TSP 100 includes a VXM 110 for performing operations on vectors (i.e., one-dimensional arrays of values). Other elements of the system are arranged symmetrically on either side of the VXM 110 to optimize processing speed. For example, the VXM 110 is adjacent to MEMs 111-112 and SXMs 113-114 to control routing of data, data domain and presentation controllers (or numerical interpretation modules (NIMs)) 115-116, and MXMs 117-118. An ICU 120 controls the flow of data and execution of operations across blocks 110-118, for example. The TSP 100 can further include communications circuits such as chip-to-chip (C2C) circuits 123-124 and an external communication circuit (e.g., PCIe) 121. The TSP 100 can, for example, further include a chip control unit (CCU) 122 to control boot operations, clock resets, and other low level setup operations.

FIG. 1C illustrates organization and data flow within a row of the TSP 100, in accordance with some embodiments. As shown in FIG. 1C, each row of the two-dimensional on-chip mesh of the TSP 100 contains a cross section of all functional slices, e.g., N×N array of MXMs (e.g., N=320) configured for both integer (INT) and floating-point (FP) numerics (e.g., INT8 and FP16), S MEM functional slices (e.g., S=44), VXM functional slices with V vector ALUs per lane (e.g., V=16), and SXM functional slices. In this organization, each functional slice is independently controlled by a sequence of instructions specific to its on-chip role fetched by a corresponding array of ICUs (e.g., a total of I=144 ICUs). Conceptually, the functional slices are fixed and data 130 is flowing across their computational elements. As the data flows through a specific functional slice, each functional slice can optionally intercept the data operands and compute a result (e.g., in case of MXM and VXM), or move data between data transport lanes on the network (e.g., in case of SXM and MEM). Instructions flow northward from the ICUs to the functional slices, while data (operands and results) primarily flow east and west between functional slices. Any inter-lane data movement within a vector uses the on-chip network functional slice.

It is noted that the “east-west-north-south” directionality is provided herein for ease of discussion and relativity. Furthermore, the “east-west-north-south” directionality is used as a reference for explanation of processing flow as described herein and is not intended to be limited with respect to a label of a particular direction. For example, the north-south direction (i.e., direction along the vertical or Y-dimension) could be reoriented to the east-west direction (i.e., direction along the horizontal or X-dimension) and the principles currently described with east-west directionality could apply to the reoriented north-south directionality. In another example of the directionality not intended to be limited to the description per the reference noted, directionality could be referenced such that north-south is up-down and east west is right-left and the principles would accordingly apply.

In one embodiment, 320 lanes are overlaid on the TSP 100 where each computational element in the on-chip mesh operates on, e.g., 16-lanes in a SIMD manner. The 16-lane unit can be referred to herein as a “superlane” and represents a cross-section of all the functional slices on the chip. As such, a superlane represents the architecture's minimum vector length (minVL) of, e.g., 16 elements. Likewise, in one embodiment, the vertical composition of 20 tiles forming a functional slice produces a maximum vector length (max VL) of, e.g., 20×16=320 functional units. Each of the 144 independent on-chip ICUs can issue one or more instructions per clock cycle. The compiler has the explicit control of a program order in each instruction queue, e.g., by generating an assembled program 340 for execution by the ICUs and functional slices. There can be, e.g., 64 logical streams per lane for moving operands or results on-chip with 32 streams eastward and 32 streams westward. The 220 MB of globally shared SRAM delivers 32 bytes per lane of stream bandwidth and low-latency access to model parameters. For example, MEM can read and MXM can install more than e.g., 100,000 weights into a 320×320 array (i.e., 320 lanes×320 functional units) in less than 30 clock cycles including SRAM and on-chip network transit delays.

As shown in FIG. 1B and FIG. 1C, the on-chip network can be implemented as X-dim mesh and Y-dim mesh of computational elements with X-Y-X dimension order routing. Each instruction specifies the first hop direction (east or west), so memory instruction semantics have both an address and a dataflow direction. Streams are routed in the X-dimension through MEM 111/112 and routed in the Y-dimension using the SXM's 113/114 permuter and lane-shifters to move data elements vertically. The SXM's 113/114 permuter implements a permutation function that is a mathematical technique that determines the number of possible arrangements in a set when the order of the arrangements matters. Common mathematical problems involve choosing only several items from a set of items with a certain order.

The MEM 111/112 and the SXM 113/114 provide deterministic routing of stream data as the stream data flows in the X and Y dimensions, respectively. With the TSP architecture 100, functional slices interact with streams of data in a producer-consumer fashion. That is, the functional slices consume operands from streams and produce results onto a (possibly different) stream, like an assembly line operator (functional slice) and conveyor belt (stream).

Conceptually, the functional slices can be fixed and data can flow across computational elements as shown in FIG. 1C. As the data flows through the functional slice, each computational element can optionally intercept the data operands and compute a result (if the computational element comprises an arithmetic logic unit (ALU)) or move data between lanes on the network if the computational element comprises a switching element.

Streams provide a programming abstraction and are a conduit through which data flows between functional slices. Unlike GPRs, the functional slices operate on streams of parallel data flowing east or west (horizontally) across the chip. The horizontally flowing streams carrying operands intercept the vertically (northward) flowing instructions (see FIG. 1C) to perform a computation at a computational element on a functional slice. A compiler accurately maintains the chip's architectural state and uses that knowledge to ensure that instructions correctly intercept its stream operand(s).

Streams can be implemented in hardware by a chip-wide streaming register file. Streams are architecturally visible and transport operands and results between functional slices. A common software pattern involves reading operand data from one or more MEM functional slices that is then subsequently consumed and operated on by a downstream arithmetic functional slice. The results of the operation are then produced onto another stream such that they can be written back to memory or passed to subsequent computational elements. For example, a Z=X+Y operation requires four instructions: Read S1, X and Read S2, Y are executed on two MEM functional slices and directed inward toward an ALU functional slice to perform the Add S1, S2, S3. Lastly, the result can be stored back to memory via a Write S3, Z. The streams represent a collection of N-elements, operated upon in a SIMD manner by each functional slice.

By way of example, a TSP architecture makes several deliberate tradeoffs on the hardware-software interface, pushing the complexities associated with scheduling into the compiler. Specifically, it falls on the compiler to precisely schedule instructions to use the hardware correctly and efficiently. At times this involves selecting one of several means by which an algorithm or meta-operation can be realized on the hardware. Removing the control complexity of dynamic instruction scheduling for multi-issue execution units allows the ICU to be relatively small, accounting for, e.g., less than 3% of the chip area.

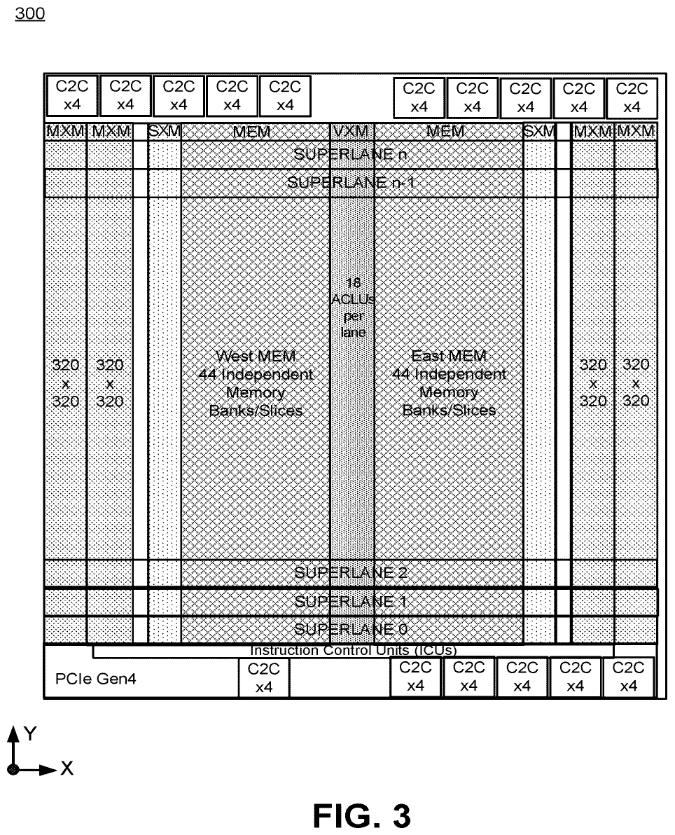

The compiler has access to, e.g., 320-lane programming abstraction overlaid on a TSP architecture (e.g., the TSP 100 in FIG. 1B or a TSP die 300 in FIG. 3) where each computational element in the on-chip mesh operates on 16-lanes in a SIMD manner. The 16-lane unit can be referred to as a “superlane” which is a cross-section of all the functional slices on the chip and the minimum granularity of computation. As such, a superlane represents the architecture's minimum vector length, minVL, of 16 elements. Likewise, the vertical composition of 20 tiles to form a functional slice (see the TSP die 300 in FIG. 3) produces a maximum vector length, max VL, of, e.g., 20×16=320 elements.

The compiler has access to, e.g., 144 independent instruction queues (i.e., ICUs) on-chip: (a) six for westward MXM including two independent two-dimensional MAC (multiply-accumulate) arrays; (b) 14 for westward SXM for intra-superlane and inter-lane switching by rearranging elements of vectors; (c) 44 for westward MEM including 44 parallel functional slices of static random-access memory (SRAM); (d) 16 for VXM including 16 vector ALUs per lane; (e) 44 for eastward MEM-including 44 parallel functional slices of SRAM; (f) 14 for eastward SXM; and (g) six for eastward MXM including two independent two-dimensional MAC arrays, whereas each instruction queue can issue one or more instructions per cycle and the compiler has explicit control of the program order in each instruction queue.

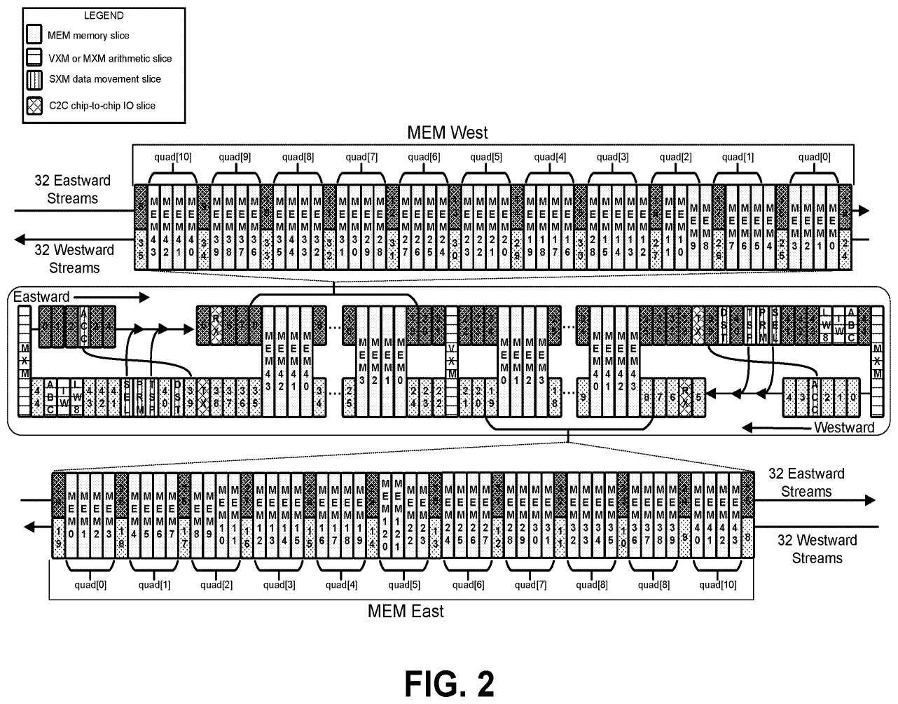

The compiler has access to, e.g., 64 logical streams per lane. For example, 32 logical streams are required to operate on 16 minVL per lane for moving operands or results on-chip with 32 streams eastward, and 32 streams westward, as shown in FIG. 2.

The compiler has access to, e.g., 220 MBytes of globally shared SRAM, in one embodiment, that delivers 32 bytes per lane of stream bandwidth and low-latency access to model parameters. For example, MEM can read and MXM can install 400K weights into all four 320×320 arrays in less than 40 operational cycles including SRAM and on-chip network transit delay.

Streams can be designated by both an identifier (0, . . . , 31) and direction. For example, in (28) designates stream 28 inward, and out (24) designates stream 24 toward the outward edge of the chip. The direction of a stream can be designated as inward (toward the chip bisection) or outward (toward the outward edge of the chip), or the direction can be designated as eastward or westward, as shown in FIG. 1C and FIG. 2.

The components of a superlane can be organized spatially as shown in FIG. 1C. The instruction set architecture (ISA) of the TSP defines instructions spanning different functional areas. The partitioned global address space (PGAS) presented by the MEM functional slices provides memory semantics for vectors to be addressed from SRAM and loaded into an architecturally visible stream with a direction of dataflow toward the functional slice intending to operate on them.

The first functional area (i.e., ICU) provides explicit instruction fetching with IFetch instruction(s), and inter-slice synchronization using Sync and Notify instructions to perform chip-wide barrier synchronization among participating functional slices. A repeated-NOP (no-op) instruction allows for precise cycle-by-cycle control of inter-instruction delay. For example, the compiler has cycle-accurate control when scheduling two operations A and B using an intervening NOP so that N cycles separate them, e.g., OpA NOP (N) OpB.

The second functional area (i.e., VXM) consists of, e.g., a 4×4 mesh of ALUs in each lane for pointwise arithmetic operations.

The third functional area (i.e., MXM) consists of, e.g., four independent two-dimensional MAC arrays that operate on INT8, FP16 or FP32 data types.

On-chip data movement uses the fourth functional area (i.e., SXM) for intra-superlane and inter-lane switching by rearranging elements of vectors. The SXM is analogous to the NET interface to communicate between cores in FIG. 1A. Together the MEM and SXM work in tandem to form the X-Y dimensional movement of data across the on-chip network.

The fifth functional area (i.e., the east and west hemisphere of on-chip MEM module) is composed of, e.g., 44 parallel MEM functional slices of SRAM and can provide the memory access concurrency necessary to fully utilize the 32 streams in each East or West direction. Each functional slice provides 13-bits of physical addressing of 16-byte memory words, and each byte maps to a lane for a total of, e.g., 220 MBytes of on-chip SRAM.

An additional sixth functional area includes C2C modules configured to provide Send and Receive primitives for exchanging 320-byte vectors between a pair of TSP chips. One possible TSP implementation (e.g., the TSP die 500) has, e.g., a total of 16×4 links operating at 30 Gbps each for a total off-chip bandwidth of 16×4×30 Gbps×2 directions=3.84 Tb/s (Tera-bytes per second) of off-chip pin bandwidth that can be flexibly partitioned to support high-radix interconnection networks of TSPs for large-scale systems. The host interface for peripheral component interconnect express (PCIe) Gen4 can be also handled in this module. The host interface can provide a lightweight direct memory access (DMA) engine to emplace a model onto the TSP memory and provide an entry point for bootstrapping the model execution. The host interface can also provide a general mechanism for passing interrupts to the host, which is necessary in the event a multi-bit memory error is observed, for example.

Table I provides a summary of example instructions for each functional slice, in accordance with some embodiments.

TABLE I
SUMMARY OF INSTRUCTIONS
FOR EACH FUNCTIONAL SLICE

| | Instruction | Description |
|---|---|---|
| ICU | NOP N | No-operation, can be repeated N times to |
| | | delay by N cycles |
| | Ifetch | Fetch instructions from streams or |
| | | local memory |
| | Sync | Parks at the head of the instruction dispatch |
| | | queue to await barrier notification |
| | Notify | Releases the pending barrier operations |
| | | causing instruction flow to resume |
| | Config | Configure low-power mode |
| | Repeat n, d | Repeat the previous instruction n times, with |
| | | d cycles between iterations |
| MEM | Read a, s | Load vector at address a onto stream s |
| | Write a, s | Store stream s register contents into |
| | | main memory address a |
| | Gather s, map | Indirectly read addresses pointed to by |
| | | map putting onto stream s |
| | Scatter s, map | Indirectly store stream s into address in |
| | | the map stream |
| VXM | unary | z = op x pointwise operation on 1 operand, |
| | operation | x, producing 1 result, z (e.g., mask, negate) |
| | binary | z = x op y pointwise operations with 2 |
| | operation type | operands x and y producing 1 result, z (e.g., |
| | | add, mul, sub) |
| | conversions | Converting fixed point to floating point, and |
| | | vice versa |
| | ReLU | Rectified linear unit activation |
| | | function max(0, x) |
| | TanH | Hyperbolic tangent - |
| | | activation function |
| | Exp | Exponentiation e^{x} |
| | RSqrt | Reciprocal square root |
| MXM | LW | Load weights (LW) from streams to |
| | | weight buffer |
| | IW | Install weights (IW) from streams or LW |
| | | buffer into the 320 × 320 array |
| | ABC | Activation buffer control (ABC) to initiate |
| | | and coordinate arriving activations |
| | ACC | Accumulate (ACC) either INT32 or FP32 |
| | | result from MXM |
| SXM | Shift up/down N | Lane-shift streams up/down by N lanes, and |
| | | Select between North/South shifted vectors |
| | Permute map | Bijective permute 320 inputs [symbol] outputs |
| | Distribute map | Rearrange or replicate data within a |
| | | superlane (16 lanes) |
| | Rotate stream | Rotate n × n input data to generate n² output |
| | | streams with all possible rotations (n = 3 or |
| | | n = 4) |
| | Transpose sg16 | Transpose 16 × 16 elements producing 16 |
| | | output streams with rows and columns |
| | | interchanged |
| C2C | Deskew | Manage skew across plesiochronous links |
| | Send | Send a 320-byte vector |
| | Receive | Receive a 320-byte vector, emplacing it in |
| | | main memory |

A sequence of instructions performed on different functional slices can be chained to create more complex actions without the need to write back intermediate results to memory. This can allow efficient processing of streams at full bandwidth and lowest latency.

Machine learning algorithms typically operate on vectors with coefficients of a specified data type (e.g., INT8, FP16, etc.). These vectors can be interpreted as an abstraction over the underlying data, whose elements can be processed by the same operation in a SIMD manner. The TSP operates on vectors that can be organized into rank-2 tensors, and relies on the graph-lowering compiler to transform higher rank tensors into rank-2 tensors.

The TSP's programming model can represent a producer-consumer model where each functional slice acts as a consumer and a producer of one or more streams. When a vector is read from a main memory, the vector can be given a stream identifier (0, . . . , 31) and direction: eastward, or westward. Once the vector is read into a stream register, the vector becomes a stream and can “flow” in the given direction in the following sense: given spatially adjacent functional slices at coordinates x₀, x₁, x₂ (where the spatial coordinate increases in the direction of flow), then at a given time t₁, the vector representing stream s₁ at functional slice x₁ can be accessed as operands by that functional slice. Similarly, the functional slices at x₀ and x₂ would have access to different stream values for the same stream register. In the following cycle tᵢ₊₁, the value s₁ either propagates to the functional slice at x₂, or else the value s₁ is overwritten with a result r₁ produced by the functional slice at x₁ at cycle t. Similarly, the stream value so that was present to be consumed by the functional slice at coordinate x₀ at time t₁ would be (absent x₀ overwriting the value at time t₁) available in the next cycle tᵢ₊₁ to the functional slice at x₁. Stream operands can be steered toward the functional slice that is consuming the stream operands and producing a result stream. Streams flow constantly across the chip, serving as how functional slices communicate with one another. FIG. 2 provides a graphical depiction of the interleaving of functional units and stream registers that combine to support this programming model.

In the TSP programming model, an instruction can be issued on a functional slice at a given compiler-scheduled time t and execute as a SIMD operation on stream-supplied operand vectors (e.g., of up to 320-elements), producing vectors of the same length on result streams. For example, at the micro-architectural level, the 320-element SIMD instruction can be pipelined across the vertical stack of computational elements in the functional slice. That is, at the scheduled time t, the instruction would be issued to the bottom-most computational element of the functional slice, e.g., corresponding to the first 16-element superlane of operand/result vectors. In the subsequent operational cycle, the instruction would be propagated to the next computational element northward in the functional slice, which in turn executes the instruction on the next 16-element super lane of operand vectors. This process can continue cycle-by-cycle until the process has traversed, e.g., all 20 computational elements in the functional slice. The combination of vertical instruction pipelining described above, along with the need for operands and instructions to coincide at a precise time, can result in a spatial “stagger” of SIMD operand and result data.

An on-chip deterministic memory can be implemented as a SRAM with multiple MEM slices. The on-chip deterministic memory (MEM) supplies operands for each functional slice by reading an address from a MEM slice, denoted MEMᵢ. MEM can be partitioned into two hemispheres (e.g., West MEM and East MEM, as shown for the TSP die 300 in FIG. 3), each having, e.g., 44 MEM slices numbered 0 to 43. Slice MEM₀ is the closest to the VXM and slice MEM₄₃ is the nearest to the SXM. Each MEM slice comprises, e.g., 20 tiles, arranged in a vertical stack, yielding a 2.5 Mebibyte (Mibyte) per-slice capacity, or 220 MiBytes for all 88 slices on-chip, thus providing the memory concurrency to supply 32 operands per lane, every cycle.

The MEM slices of the on-chip deterministic memory can be partitioned into 16-byte words, each word can spread across a superlane, and each byte of each word can occupy a lane of an input channel or an output feature. That is, byte 0 can be lane0, byte 1 can be lane1, etc. Each tile produces a portion of the vector, which is concatenated with the 16 elements from the adjacent tile beneath. Instructions execute in a cycle-by-cycle staggered manner across all 20 tiles in the slice: instructions flow northward over the span of 20 cycles visiting each tile in the slice.

The MEM slices of the on-chip deterministic memory provide the programming abstraction of a partitioned global shared address space with the address space laid out uniformly across the 88 slices. Each MEM slice contains pseudo-dual-port SRAMs that can service a pair of read and write requests simultaneously when the read and write requests are not targeting the same bank of the on-chip deterministic memory. As such, the bank bit is exposed so that the compiler can manage the underlying SRAM efficiently and appropriately. This can allow the compiler to take advantage of all 88 slices in 176-way memory concurrency-88 slices each with two banks—to read operands to or store results from streams.

To maximize stream concurrency, the compiler allocates memory for tensor's concurrent stream operands into separate MEM slices—as streams propagate through the MEM slices, the streams “pick up” operands from the MEM slices enroute to the MXM. This fine-grain memory management requires that the various levels of memory concurrency are exposed in the ISA allowing the compiler to explicitly schedule individual banks in each MEM slice. In an embodiment, operands are simultaneously read from one bank and results are written to the other bank in the same MEM slice.

Conventional CPUs rely on a memory hierarchy to implicitly move data between caches to service load/store operations. Cache hierarchies introduce a reactive agent in the data path that causes the undesired unpredictability, or non-determinism, in the data path to provide the illusion of sequentially consistent memory transactions within the memory hierarchy. Unlike a conventional CPU, the on-chip deterministic memory provides a thin layer of memory management that can be used to identify memory concurrency on an operation-by-operation basis.

### Scale Computing in Deterministic Cloud System

Embodiments of the present disclosure are directed to scale computing at a deterministic cloud system (i.e., cloud computing environment) having a plurality of deterministic streaming processors. Each deterministic streaming processor can be a TSP commercially available from GROQ, INC, e.g., the TSP 100 of FIG. 1B or the TSP die 300 of FIG. 3. The deterministic cloud system of the present disclosure is configured to execute natural language processing (NLP) workloads, natural language understanding (NLU) workloads, and Long Short Term Memory (LSTM) workloads with a high level of QoE. Embodiments of the present disclosure are further directed to a method of meeting demanding QoE requirements for Deep Neural Networks (DNN) inferences is presented herein as a service in the cloud computing environment.

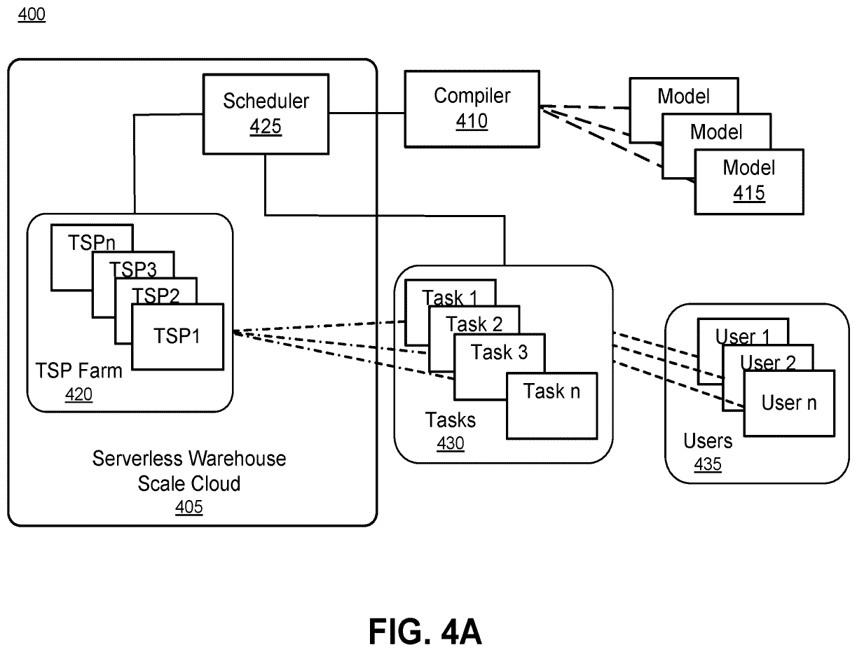

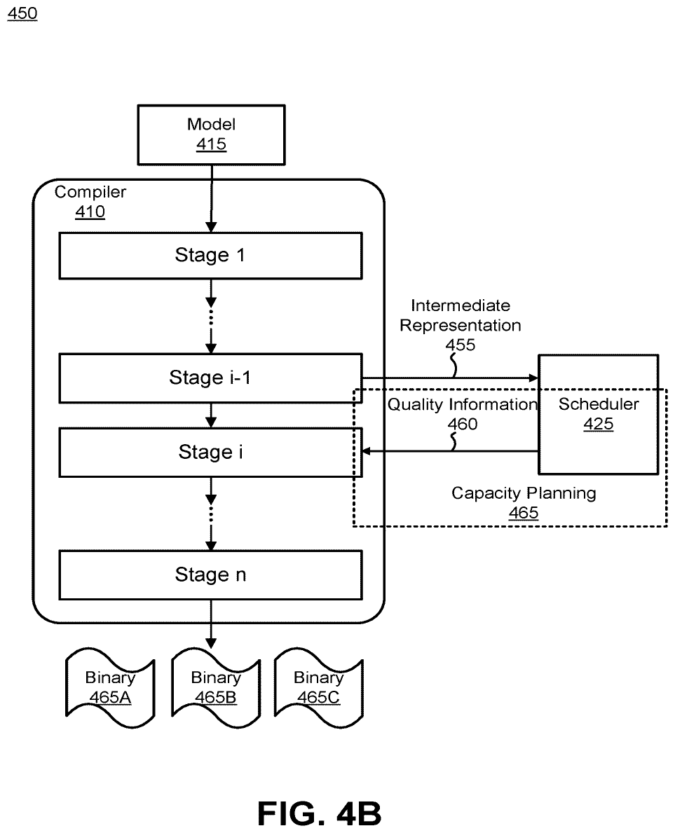

FIG. 4A illustrates an example deterministic cloud system 400, in accordance with some embodiments. The deterministic cloud system 400 is implemented as a serverless cloud configuration with multiple TSPs configured to manage, e.g., Deep Neural Network (DNN) inference workloads. The deterministic cloud system 400 includes a plurality of integrated circuits (e.g., deterministic streaming processors or TSPs) deployed in a serverless cloud computing environment. The deterministic cloud system 400 includes a serverless warehouse scale cloud 405 and a compiler 410. The compiler 410 is configured for compiling a plurality of models 415 (e.g., machine learning models) for execution at the serverless warehouse scale cloud 405. The serverless warehouse scale cloud 405 includes a TSP farm 420 and a scheduler 425. The TSP farm 420 includes a plurality of deterministic streaming processors (e.g., TSPs−TSP1, TSP2, . . . , TSPn). A plurality of tasks 430 (e.g., Task 1, Task 2, . . . , Task n) can run at one or more deterministic streaming processors (e.g., one or more TSPs) of the TSP farm 420. A plurality of users 435 (e.g., User 1, User 2, . . . , User n) are associated with the plurality of tasks 430.

Each model 415 represents a standalone executable (after compilation by the compiler 410) that can run on one or more TSPs of the TSP farm 420. Each task 430 represents an inbound request to run a set of inputs against a corresponding model 415. The compiler 410 and the scheduler 425 represent separate entities (or components) of the deterministic cloud system 400. However, the compiler 410 and the scheduler 425 are interrelated as the scheduler 425 can invoke the compiler 410 as part of a dependency routine so that the scheduler 425 can obtain deterministic information in relation to the tasks 420 determined by the compiler 410. In one or more embodiments, the deterministic cloud system 400 with the cloud-based TSP farm 420 can run models 415 such as NLP models and/or NLU models. The scheduler 425 can schedule one or more tasks 430 to an appropriate TSP or a cluster of TSPs within the TSP farm 420 depending on a particular task 430. The scheduler 425 is configured to evaluate the tasks 430, the type of compiled model 415, and resources of TSPs within the TSP farm 420 that are required to generate the inference result with a desired level of QoS and/or QoE.

A workload (e.g., one or more tasks 430) run at the deterministic cloud system 400 can be any machine learning or artificial intelligence workload. The deterministic cloud system 400 is particularly well suited for NLP workloads, NLU workloads and LSTM workloads, by way of example as many other workloads are suitable for deployment on the deterministic cloud system 400. The NLP and NLU concepts both deal with the relationship between natural language (e.g., as in what humans speak) and artificial intelligence. The LSTM can be used to model univariate time series forecasting problems. These types of problems comprise a single series of observations and a corresponding model 415 is required to learn from the series of past observations to predict the next value in the sequence.

### Deterministic Performance of Deterministic Cloud System

Embodiments of the present disclosure are directed to various strategies that the deterministic cloud system 400 can utilize to reduce (or, in some cases, eliminate) scheduling uncertainties and provide qualitative guarantees to users 435 in the form of contractual QoS and/or QoE requirements. The deterministic cloud system 400 can manage a cluster of racks of TSPs (e.g., implemented as the TSP farm 420). The scheduler 425 assigns tasks 430 originating from a set of users 435 to a set of TSPs as part of, e.g., the TSP farm 420. The scheduler 425 can utilize the compiler 410 as a dependency (e.g., as a subroutine or a distinct system component) to have precise information about how much time each task 430 takes to finish on a specific portion of computational resources of the TSP farm 420 (e.g., on a specific TSP or group of TSPs of the TSP farm 420). The scheduler 425 is configured to allocate resources (e.g., one or more TSPs of the TSP farm 420) to tasks 430 with task latencies known a priori so that no predefined QoE and/or QoS constraints are violated. In this manner, the deterministic cloud system 400 can meet demanding QoE and/or QoS requirements for, e.g., DNN inferences workloads of different users 435.

The scheduler 425 evaluates (e.g., based on deterministic information from the compiler 410) a respective latency of each task 430 in a queue and adjusts an accuracy and/or quality for execution of each task 430 when utilizing available computational resources of the TSP farm 420 (e.g., as described in detail below in relation to FIG. 4B). A task 430 that runs at the TSP farm 420 can be configured to achieve a level of confidence that provides a sufficiently accurate result, while the accuracy of other tasks 430 in the queue is adjusted to enable a higher QoS. Due to the deterministic nature of TSPs within the TSP farm 420, the scheduler 425 is aware of the exact amount of computation that can be performed within a defined time period. The scheduler 425 can leverage the compiler 410 to adjust, based on the known amount of computation, the accuracy and/or quality of task results until all tasks can be completed by required contractual deadlines.

In some embodiments, the scheduler 425 determines which portion of the deterministic cloud system 400 (e.g., which set of one or more TSPs in the TSP farm 420) to assign a task 430. For example, a first smaller task 430 can be deployed on a first TSP (e.g., an older and smaller version of a TSP in the TSP farm 420), and a second larger task 430 can be deployed on a second TSP (e.g., a newer and larger version of a TSP in the TSP farm 420). In general, the scheduler 425 can assign tasks 430 to one or more TSPs in the farm 420 in any way the scheduler 425 chooses to in accordance with deterministic information provided by the compiler 410.

The deterministic cloud system 400 can run a workload (i.e., a stream of incoming tasks 430) that is otherwise very expensive to process using the traditional CPU or GPU computational resources. The workload can vary and the request patterns of users 435 can be unknown. By employing the TSP farm 420, it is possible to dynamically change the quality of output results. For example, the TSP farm 420 is configured to process 200 tasks at a first quality level or 400 tasks at a second quality level that is lower than the first quality level. Details about dynamically changing the quality of output results are described below in relation to FIG. 4B.

An architecture of each TSP chip within the TSP farm 420 allows for all models 415 to have completely deterministic performance with respect to computational cycles (e.g., clock cycles). The number of computational cycles required for execution of each model 415 is known by the compiler 410 before the models 415 are run on one or more TSPs of the TSP farm 420. The performance with respect to real time still depends on the clock speed of each TSP chip of the TSP farm 420—faster clock speeds yield better performance than slower clock speeds. Managing clock speeds of TSPs within the TSP farm 420 is one way to ensure preferred levels of QoS and/or QoE metrics. For TSPs within the TSP farm 420 serving latency sensitive tasks 430, overclocking during peak loads of tasks 430 would help to ensure that contractual agreements with users 435 are not broken. Similarly, one or more TSPs within the TSP farm 420 can be underclocked when running tasks 430 that are further from breaching contractual agreements with users 435. This can be useful for hardware longevity which reduces operational expenditures for a service provider of the TSP farm 420.

The key idea behind this strategy is that the effects of adjusting accuracy and quality metrics of tasks 430 and/or clock speeds of TSPs within the TSP farm 420 are known to the compiler 410 because of the deterministic architecture of each TSP in the TSP farm 420. Hence, the scheduler 425 can utilize this deterministic information from the compiler 410 and confidently approach a contractual deadline for execution of each task 430 without exceeding the contractual deadline. The same cannot be said for traditional non-deterministic architectures that require substantially more compute head room to ensure that contractual agreements are not violated.

Because each TSP within the TSP farm 420 is a deterministic streaming processor, the scheduler 425 can leverage the compiler 410 to accurately predict an execution time and latency for each task 430, as well as a quality of result for each task 430. Thus, a service provider can guarantee that each user 435 obtains a required queries per second (QPS) or inferences per second (IPS). However, the quality of results can be varied when a burst of tasks 430 are received.

In one or more embodiments, service level agreement (SLA)-based programming interface allows each user 435 to select a corresponding QoE for each task 430. Specifically, a QoE can be determined by knowing in advance the deterministic performance of each TSP in the TSP farm 420 and adjusting either computational resources or quality to accommodate bursts of tasks 430. For example, if there is an initial set of three tasks 430 for execution and the TSP farm 420 has the capacity to handle five simultaneous tasks 430, the scheduler 425 can select (e.g., via the compiler 410) a first model 415 that outputs results of a maximum quality. However, if a request for execution of ten tasks 430 is received at the TSP farm 420 and the TSP farm 420 can handle five simultaneous tasks 430, the scheduler 425 can elect to use (e.g., via the compiler 410) a second model 415 that outputs a result for each task 430 with a lower quality level, e.g., with a lower result accuracy but with a guaranteed latency. Advantageously, there is no increase in latency, no need to queue tasks 430, and no need to calculate a batch size since the batch size is always one.

By employing the compiler 410 that produces deterministic executables, it is possible to directly calculate a required level of QoS and provide the necessary computational resources of TSPs within the TSP farm 420 for a time duration required to complete the tasks 430 without guessing when each task 430 would complete. In contrast, by employing a cloud-hosted GPU server process, a continuous stream of incoming DNN inference tasks are sent by users, each task with a specified latency. This provides a time budget to process the query. Typically, a scheduler would prepare a batch of multiple tasks and select a suitable cloud-hosted GPU server to process the batched tasks. Thus, the cloud-hosted GPU server allocates computational resources proportional to changing task workloads. Unfortunately, the batch size would impact latency, processing time and complicates the preprocessing that is required to execute the workload.

By employing the compiler 410 that produces deterministic executables, it is possible to characterize the TSP farm 420 in advance of the arrival of each task 430. Characterization of the TSP farm 420 accounts for availability of resources of TSPs within the TSP farm 420, which varies over time or by configuration. By understanding a resource map of the TSP farm 420, the scheduler 425 targets one or more specific TSPs within the TSP farm 420 for one or more specific workloads (e.g., one or more tasks 430).

Advantageously, when a workload burst (e.g., burst of tasks 430) occurs, one or more additional TSPs within the TSP farm 420 can be deployed to handle the tasks 430 with a calculated latency, or the execution of tasks 430 can be precisely adjusted to meet specified levels of QoS. In one embodiment, a first subset of models 415 (e.g., after being compiled by the compiler 410) can be deployed on individual TSPs within the TSP farm 420 having required physical resources. In another embodiment, a second subset of models 415 (e.g., after being compiled by the compiler 410) can be deployed on a set of TSPs within the TSP farm 420, wherein the set of TSPs is configured to function as a single deterministic node. In either deployment, one or more TSPs of the TSP farm 420 can exhibit varying capacities of each functional unit. For example, a first portion of TSPs of the TSP farm 420 can have more on-board MEM functional units (e.g., SRAM) and fewer MXM functional units in comparison with a second portion of TSPs of the TSP farm 420, so that the first portion of TSPs can perform, e.g., more dot product operations per second. As the compiler 410 is configured to build a functional set of instructions that would take advantage of (or be precisely tailored to) the available resources in the TSP farm 420, the scheduler 425 can allocate workloads (e.g., tasks 430) to TSPs of the TSP farm 420 that have sufficient resources for that workload.

The compiler 410 can calculate resource requirements for each model 415 during compilation of the model 415. The scheduler 425 can select one or more TSPs of the TSP farm 420 for running the compiled model 415 by utilizing available resources of the selected TSPs. The compiler 410 calculates the exact amount of computation (i.e., deterministic information) that can be performed within a time period and adjusts the accuracy or quality of outputs until all tasks 430 can be completed by their contractually required deadlines.

In one or more embodiments, the scheduler 425 comprises a function that evaluates a latency of each task 430, based on the deterministic information from the compiler 410. Based on the evaluated latency for each task 430, the scheduler 425 adjusts the accuracy or quality up to use the available computational resources of the TSP farm 420. When a computation achieves a level of confidence that a sufficiently accurate result has been generated and the task 430 ends, the accuracy of other tasks 430 in the queue can be adjusted. Also, when new tasks 430 are added to the queue, the quality and/or accuracy can be adjusted for all tasks 430 in the queue to meet the contractual agreements with users 435.

In some embodiments, the scheduler 425 allows that the quality would be higher for tasks 430 in the queue based on the deterministic information obtained from the compiler 410. Accordingly, the quality of each queued task 430 can be adjusted before the task 430 runs at the resources of the TSP farm 420. In some embodiments, each task 430 in the queue is tagged with information so the scheduler 425 can adjust the time allocated to each task 430 prior to sending the task 430 to a resource of the TSP farm 420. The compiler 410 (or, alternatively, a model developer) can recognize one or more places (e.g., checkpoints) in a model 415 where there is a clean break between different parts of the model 415. Using this information, the scheduler 425 can swap parts of the model 415 in between the checkpoints if a corresponding task 430 has not executed it yet. Note that the start and end of a model 415 can also count as checkpoints.

When multiple TSPs of the TSP farm 420 run the computation, the scheduler 425 can manage the pending tasks 430 over the multiple TSPs of the TSP farm 420. Where multiple computation units are combined with a known performance impact enables the tasks 430 to finish computations with a lower latency. The key to the flexible approach of managing the QoE and/or QoS is that the scheduler 425 knows the exact number of computational cycles (e.g., clock cycles) it would take to perform the computation once the model 415 has been compiled by the compiler 410 for execution at one or more TSPs of the TSP farm 420.

Model Variation with Partial Compilation at Deterministic Cloud System

FIG. 4B illustrates an example process of compiling a model 415 for the deterministic cloud system 400 based on partial compilation and model variation, in accordance with some embodiments. The compiler 410 operates by compiling the model 415 through a list of stages (e.g., stage 1, . . . , stage i−1, stage i, . . . , stage n, as shown in FIG. 4B), where each stage is applied one after another with an output of one stage being fed as an input into a subsequent stage. The output/input in between stages can be referred to herein as “intermediate representation.” As shown in FIG. 4B, the output of stage i−1, referred to as intermediate representation 455, can be also fed to the scheduler 425. The scheduler 425 produces quality information 460 for a plurality of binaries (e.g., three binaries) that can be potentially executed at the TSP farm 420. The quality information 460 can include information about accuracy and/or latency for each of the plurality of binaries when executed at specific resources of the TSP farm 420. The scheduler 425 provides the quality information 460 to stage i of the compiler 410. Then, the compiler 410 can proceed to compile the intermediate representation 455 using the quality information 460 to generate the plurality of binaries (e.g., binary 465A, 465B, 465C) as outputs of the last stage n of the compiler 410. This process can occur statically in the background to avoid the critical path of real-time scheduling of task 430 done by the scheduler 425.

One way to manage bursty traffic (e.g., burst of tasks 430) can be to have various binaries (e.g., binary 465A, 465B, 465C) associated with a given model 415 that can serve the same request but can allow a tradeoff between result quality and performance. If the scheduler 425 sees a burst of traffic, the scheduler 425 can elect to serve the requests with a binary that yields better performance at lower quality results to meet an SLA. There can be multiple options for choosing the tradeoff between performance and quality, as well as the possibility of having several binaries to choose from. One way to choose among these multiple options would be to have the model 415 be partially compiled to a lowest intermediate representation possible (e.g., intermediate representation 455) before requiring more information (e.g., the quality information 460 for the plurality of binaries) for how the compilation should continue. While the model 415 is being registered, the scheduler 425 performs the necessary capacity planning and decides how many variations there should be and the associated quality information for each variation of executable binary.

The benefits of involving the scheduler 425 in the compilation process arise from the fact that the scheduler 425 supports a plurality of models 415 for a plurality of users 435. If a new model 415 belonging to an arbitrary user 435 is registered to the TSP farm 420 with pre-existing registered models 415, the scheduler 425 can elect to change which binary variations would be utilized for any subset of existing pre-registered models 415 as part of its optimization routine (e.g., when ensuring the drainage condition for capacity planning, as discussed in more detail in the section below). Partial compilation is useful to expedite this process because, otherwise, recompilation of models 415 would be required. Additionally, the scheduler 415 can perform its part of compilation process outside the critical path of incoming requests as, e.g., a background job. Otherwise, the non-determinism and an additional latency would be introduced to the incoming requests as model compilation itself is not deterministic.

The compiler 410 performs pre-compilation of the model 415 (i.e., source code) to the intermediate representation 460 before executable binaries 465A, 465B, 465C are generated. The scheduler 425 is configured to provide the quality information 460 for the binaries 465A, 465B, 465C, and the scheduler 425 invokes the compiler 410 to proceed with compilation starting from the intermediate representation 460 (e.g., through stages i, . . . , n) to produce the binaries 465A, 465B, 465C. The scheduler 425 invokes the compiler 410 to proceed with compilation starting from the stage i as, e.g., part of a subroutine during a capacity planning process 465 of the scheduler 425. The compilation from stage 1 to stage i−1 can be performed during any process of the compiler as long as the scheduler 425 receives from the compiler 410 the intermediate representation 455 as its input.

The benefit of splitting the compilation of model 415 between the compiler 410 and the scheduler 425 is that the scheduler 425 can dynamically modify a manner of running the compiled model 415 during runtime in the background. For example, the model 415 includes a source code defining a matrix-matrix multiplication between a first square matrix of size N×N and a second square matrix of size N×N, where N is a variable parameter. The compiler 410 compiles the model 415 into an intermediate representation 460 that represents an output of stage i−1 of the compiler. Responsibility of the scheduler 425 is to provide quality information 460 for multiple binaries associated with the model 415 once the scheduler 425 knows the exact value of parameter N, which is not known to the compiler 410. Thus, the compiler 410 compiles the model 415 from the source code to the intermediate representation 460 until the point when the value of parameter N needs to be known for the compilation process to proceed. After the value of parameter N becomes known and the scheduler 425 provides the quality information 460 back to the compiler 410, the compiler 410 can complete the compilation of the model 415. The scheduler 425 can elect to alter the value of parameter N at some later time, at which point the scheduler 425 can utilize the pre-compiled intermediate representation 460 once again, supply the compiler 410 with the altered value of parameter N, and use an output of the compilation process as a new variation of the model 415 without involving a user 435.

The same principle of split compilation between the compiler 410 and the scheduler 425 can be applied to other model 415 source code with one or more variable parameters. One additional example of such a source code is a source code of a model 415 that defines power management operations at the TSP farm 420. For example, depending on an available power budget, a model 415 can be run at a first subset of resources of the TSP farm 420 as a ‘hot’ executable binary code, or the same model 415 can be run at a second subset of resources of the TSP farm 420 as a ‘cold’ executable binary code. The compiler 410 compiles an intermediate representation 455 of the model 415 into two binary executable codes based on quality information 460 provided by the scheduler 425, i.e., a ‘hot’ binary code consuming a first power and a ‘cold’ binary code consuming a second power lower than the first power. A corresponding binary code would be run at a corresponding subset of resources of the TSP farm 420 based on an available power budget at the deterministic cloud system 400.

Another example operation that exploits the same principle of split compilation between the compiler 410 and the scheduler 425 is a dynamic networking operation. During a runtime, the scheduler 425 can choose how data is routed throughout a chip-to-chip (C2C) network of multiple TSPs in the TSP farm 420 before an executable binary code originating from a source code of a model 415 is run at a specific subset of resources of the TSP farm 420. This is particularly useful when a destination TSP of the TSP farm 420 is not known before the binary code is run at a source TSP of the TSP farm 420.

### Static Capacity Planning at Deterministic Cloud System

Deterministic architectures of TSPs within the TSP farm 420 lets the scheduler 425 know exactly how long it will take to serve a known set of tasks 430. However, the TSP farm 420 serving ad hoc customer tasks 430 does not know what tasks 430 need to be served ahead of time. If the TSP farm 420 knows an upper bound of the task 430 request load the TSP farm 420 would experience, the TSP farm 420 can guarantee execution of each task 430 with stricter SLAs at lower latencies. Additionally, the TSP farm 420 can guarantee preferred levels of QoS and/or QoE metrics for pre-determining how the task 430 would be configured to execute under the absolute worst case scenario of request loads in relation to tasks 430.

In one or more embodiments, the deterministic cloud system 400 would offer reserved execution of models 415 for customers with strict SLA requirements. This requires registering their model 415 before issuing tasks 430 by providing a variety of constraints of the TSP farm 420 and constraints of users 435. The constraints of the TSP farm 420 can be, e.g., required latency SLAs of registered models 415, quality SLAs, and accuracy SLAs. The users 435 can be constrained to issuing a maximum inferences per second (IPS) (i.e., constraining an average request load), and a maximum request queue size (i.e., constraining a peak request load). The constraints of users 435 can be enforced using, e.g., a leaky bucket algorithm where every registered model 415 would have its own leaky bucket with the leak rate set to a registered IPS of the model 415 and the bucket size set to the registered queue size of the model 415.

The scheduler 425 can ensure at any given time that the TSP farm 420 has enough compute capacity to drain the leaky buckets of every registered model 415 within each registered latency SLA bounds (e.g., the drainage condition) of the model 415. This represents the highest peak load that the TSP farm 420 would experience for the set of models 415 registered with the TSP farm 420. Because the peak load of TSP farm 420 increases only when a model 415 is registered, it is sufficient to ensure the drainage condition during the model 415 registration process. For practical reasons, the drainage condition also needs to be ensured when the compute capacity of TSP farm 420 decreases for a variety of reasons (e.g., maintenance, hardware failure, rack removal, etc.). The drainage condition does not need to be ensured for deregistration of a model 415 or upon an increase of the compute capacity of TSP farm 420 because these changes strictly expedite the bucket drainage process.

The process for ensuring the drainage condition is simplified due to the deterministic nature of the TSP farm 420. A non-real-time subcomponent of the scheduler 425 that can be referred to as a “capacity planner” (not shown in FIG. 4A) can simulate a TSP farm 420 consisting of simulated leaky buckets for all existing and newly registered models 415 that are filled with tasks 430 representing the maximum load that leaky bucket is configured to allow, a cluster of TSP racks configured identically to the real TSP cluster (e.g., that mocks TSP execution by sleeping for the amount of time a task 430 takes to deterministically execute), and a scheduler that mimics scheduling decisions the real scheduler 425 would make (which requires that the real scheduler 425 makes non-random scheduling decisions). If the simulation can drain the leaky buckets within all registered contractual agreements, then the capacity planner would proceed with the registration. Otherwise, the capacity planner determines the new registration to be infeasible and would require a user 435 to change their registration parameters to be less intensive on the TSP farm 420. This is to prevent potential violations of contractual agreements not only for the registering user 435 but also for other pre-existing users 435.

Note that it would not be possible to guarantee similar contractual agreements on a TSP farm 420 serving ad-hoc tasks 430. The capacity planner cannot perfectly predict how users 425 would send tasks 430 to the TSP farm 420 because that is a function of unknown, external processes. Planning for the worst case scenario to a similar degree would require real time analysis that is simultaneously more sophisticated and strictly less accurate than the static counterpart. The static capacity planning with prior knowledge about peak loads is a substantially more tractable problem because (1) worst case load conditions are known by the capacity planner which shrinks the state space, (2) the number of model 415 registrations is fewer than the number of tasks 430 by many orders of magnitude, and (3) the static capacity planning does not need to run in real time. Similarly, it would not be possible to guarantee such contractual agreements by utilizing a non-deterministic compute farm (e.g., GPU-based compute farm) because there would be no guarantees associated with latencies of tasks 430 at the hardware level.

Deterministic Cloud System with Defective Processors

Manufacturing of integrated circuits is typically complex and expensive, especially at modern sub-10 nm processing nodes where the cost of the wafer used as in the manufacturing process can be very expensive. The equipment needed to build the transistors, e.g., lithography equipment in the extreme ultraviolet (EUV) range, is also very expensive with the acquisition costs to set up a production line. However, manufacturing improvements afforded by the modern semiconductor fabrication equipment used to produce an integrated circuit at the new processing nodes continue to increase the density of transistors and metal per unit of area, which tends to lower the cost to produce an integrated circuit on a per transistor basis. Thus, modern integrated circuits routinely comprise billions of transistors that run at low power and high speeds. However, the increased density of transistors tends to result in poor manufacturing yields because random defects are now more likely to result in a higher percentage of non-functional integrated circuits on each wafer.

Designers of integrated circuits tend to mitigate the effects of low yield by including redundant elements that allow the integrated circuit to be reprogrammed to use the redundant element as a replacement for a defective element. For example, memory based integrated circuits often have a spare column of memory that can be substituted for a memory column that has a defective cell. In other instances, a defective element does not cause a ‘hard’ failure. Rather, the defective element causes one or more transistors to function poorly above a certain voltage or above a certain temperature. Such parametric failures result in an integrated circuit that works functionally at low temperatures or low workloads but fails to meet operational specifications as the integrated circuit warms up when functionally stressed at a high level. In other instances, the integrated circuit functions properly when operated at low voltage but stops working if operated at a slightly higher voltage or vice-versa.

In the past, vendors would screen the integrated circuits after manufacture, and sort or bin the integrated circuits according to the operational capabilities. Integrated circuits that fully function over the intended operational voltage and temperature range would fetch a higher sales price. However, when high performance is a non-negotiable requirement, the ability to sell integrated circuits that have a mixture of soft and hard defects results in sub-optimal sales of such high-performance integrated circuits that does not adequately offset the manufacturing costs.

While the complexity of manufacturing integrated circuits is a function of the actual design goals of the integrated circuit, the manufacturing costs are mainly a function of yield. If only fully functional integrated circuits can be marketed, the cost per integrated circuit will be high. Conversely, if integrated circuits having a soft failure and/or a hard failure could be adapted to provide a specified QoS that effectively hides the defects caused by yield problems during manufacturing, then such integrated circuits could also be marketed and thereby reduce the manufacturing cost associated with the fully functional integrated circuit. More specifically, costs can be significantly improved (e.g., lowered) if integrated circuits that are less than fully functional could be used for applications where the lack of full functionality does not impact the specified QoS.

The deterministic cloud system 400 includes a plurality of integrated circuits (e.g., TSP chips with the TSP farm 420), where each integrated circuit (e.g., TSP chip) can include a defect and can be deployed in a selected configuration. The scheduler 425 is aware of a resource availability map identifying each integrated circuit (e.g., TSP chip). The scheduler 425 utilizes the compiler 410 to evaluate a model 415 to obtain deterministic latency information for running the model 415. Based on the deterministic latency information from the compiler 410, the scheduler 425 selects at least one integrated circuit (e.g., at least one TSP chip of the TSP farm 420) capable of providing sufficient resources to execute the model 415 to meet the specified level of QoS and/or QoE despite the defect that might occur during manufacturing of the TSP chip. The plurality of integrated circuits (e.g., TSP chips of the TSP farm 420) can be deployed with a rack. Alternatively, the plurality of integrated circuits (e.g., TSP chips of the TSP farm 420) can be deployed on a card. The resource map known by the scheduler 425 comprises a list of each deployed integrated circuit (e.g., TSP chip of the TSP farm 420) and their configuration. The resource map can further include a defect classification identifying a defect associated with each integrated circuit (e.g., TSP chip of the TSP farm 420). Alternatively or additionally, the resource map includes a list of available resources of integrated circuit (e.g. each TSP chip of the TSP farm 420). Alternatively or additionally, the resource map comprises a QoS designation for each user 435.

### Example Process Flow

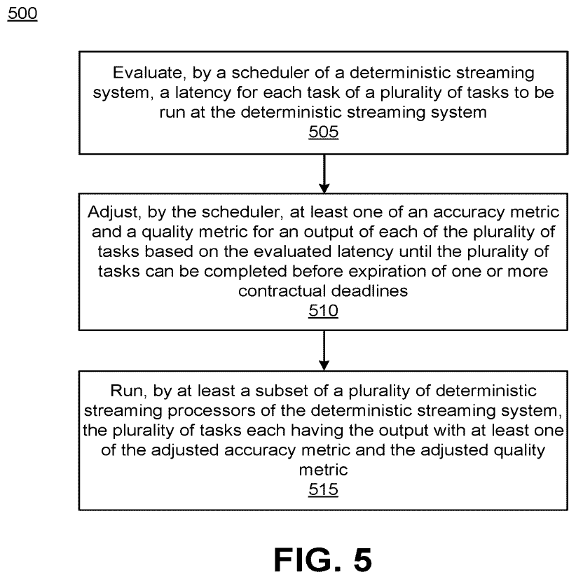

FIG. 5 is a flowchart illustrating a method 500 of scalable deterministic computing at a deterministic streaming system (e.g., TSP system) in a cloud computing environment, in accordance with some embodiments. The deterministic streaming system includes a plurality of deterministic streaming processors (e.g., multiple TSP chips or card) deployed in the cloud computing environment, a scheduler, a compiler running on at least one computer processor, and a non-transitory computer-readable storage medium for storing computer executable instructions. Each deterministic streaming processor of the deterministic streaming system can be an embodiment of the TSP 100 or an embodiment of the TSP 300.

The operations of method 500 can be initiated by the compiler operating on at least one computer processor and/or on a host server integrated into the deterministic streaming system or separate from the deterministic streaming system. The compiler can utilize as its input a model (e.g., a machine learning model) for the one or more deterministic streaming processors and outputs instructions for configuring operation of the one or more deterministic streaming processors and the deterministic streaming system as a whole.

The deterministic streaming system evaluates 505 (e.g., by the scheduler) a latency for each task of a plurality of tasks to be run at the deterministic streaming system. The deterministic streaming system adjusts 510 (e.g., by the scheduler) at least one of an accuracy metric and a quality metric for an output of each of the plurality of tasks based on the evaluated latency until the plurality of tasks can be completed before expiration of one or more contractual deadlines. The deterministic streaming system runs 515, by at least a subset of the plurality of deterministic streaming processors of the deterministic streaming system, the plurality of tasks each having the output with at least one of the adjusted accuracy metric and the adjusted quality metric.

The deterministic streaming system selects (e.g., by the scheduler) a pre-compiled model variation for compilation (e.g., by the compiler). The deterministic streaming system selects (e.g., by the scheduler) quality and accuracy information during a static capacity planning process for when the scheduler decides which model variations should be compiled. The compiler performs partial compilation of at least one model into an intermediate representation before requiring more information from the scheduler on how to finish the compilation. The scheduler generates the information for the compiler during the static capacity planning.

In some embodiments, the deterministic streaming system compiles (e.g., by the compiler) source code of each model of a plurality of models associated with the plurality of tasks into an intermediate representation. The deterministic streaming system generates (e.g., by the scheduler) quality information for a plurality of binary executables, based on the intermediate representation. The deterministic streaming system generates (e.g., by the scheduler) the quality information while performing one or more static capacity planning jobs when one or more new models of the plurality of models are being registered. The deterministic streaming system compiles (e.g., by the compiler) the intermediate representation into the plurality of binary executables using the generated quality information. The compilation of models occurs statically in the background. The deterministic streaming system selects (e.g., by the scheduler) a binary executable of the plurality of binary executables for execution at one or more of the deterministic streaming processors, based on a number of computational cycles required for each of the plurality of binary executables to be executed.

The deterministic streaming system calculates (e.g., by the compiler) an amount of computation that can be performed within a period of time for each of the plurality of tasks, and provides information about the calculated amount of computation to the scheduler for the evaluation of latency for each task. The deterministic streaming system selects (e.g., by the scheduler) at least the subset of the plurality of deterministic streaming processors to run the plurality of tasks based on a resource availability map identifying each deterministic streaming processor of the plurality of deterministic streaming processors. The resource availability map comprises a list of each deployed deterministic streaming processor of the plurality of deterministic streaming processors and information about a configuration of each deployed deterministic streaming processor. Alternatively or additionally, the resource availability map comprises information about a defect classification identifying a defect associated with each deterministic streaming processor of the plurality of deterministic streaming processors.

The deterministic streaming system meets a defined QoE metric based on at least the subset of the plurality of deterministic streaming processors running the plurality of tasks each having the output with at least one of the adjusted accuracy metric and the adjusted quality metric. Alternatively or additionally, the deterministic streaming system meets a defined QoS metric based on at least the subset of the plurality of deterministic streaming processors running the plurality of tasks each having the output with at least one of the adjusted accuracy metric and the adjusted quality metric.

The plurality of tasks can be associated with one or more DNN inference tasks. The plurality of deterministic streaming processors can be deployed as part of a cloud computing environment. The plurality of deterministic streaming processors can be deployed in a rack or on a card as part of the cloud computing environment.

Embodiments of the present disclosure are further directed to a system (e.g., the deterministic cloud system 400) for executing a plurality of tasks (e.g., the tasks 430) at a processor farm (e.g., the TSP farm 420). A scheduler in the system (e.g., the scheduler 420) can be configured to achieve a level of confidence for a first task of the plurality of tasks in a queue to generate a result having an accuracy metric above a threshold accuracy. The scheduler can be further configured to adjust a level of accuracy of one or more other tasks of the plurality of tasks in the queue to increase a quality metric (e.g., QoS) of the one or more other tasks, based on information about an amount of computation that can be performed at the processor farm within a defined time period. The scheduler can be further configured to adjust, based on the information, at least one of an accuracy metric and a quality metric of results generated by the plurality of tasks until the plurality of tasks can be completed by defined contractual deadlines.

In some embodiments, the scheduler assigns the plurality of tasks to one or more processors in the processor farm in accordance with deterministic information provided by a compiler of the system (e.g., the compiler 410). The scheduler can dynamically change the quality metric of the results in response to changes in a workload associated with the plurality of tasks. The compiler produces a plurality of binary executables from a source code of a model. The compiler can further characterize the processor farm in advance of an arrival of each task of the plurality of tasks to account for availability of resources within the processor farm. The scheduler produces quality information for the plurality of binary executables, the quality information including information about at least one of an accuracy metric and a latency for each of the plurality of binary executables when executed at specific resources of the processor farm. The scheduler provides the quality information to the compiler for compiling an intermediate representation of the model to generate the plurality of binary executables. In response to a plurality of requests for the plurality of tasks (e.g., bursty tasks), the scheduler serves the plurality of requests with a binary executable of the plurality of binary executables that yields a better performance at lower quality results to meet the defined contractual deadlines.

In some embodiments, the scheduler comprises a capacity planner as a non-real-time subcomponent. The capacity planner simulates the processor farm consisting of simulated leaky buckets for all existing and newly registered models that are filled with tasks representing a maximum load that any of the leaky buckets is configured to allow, a simulation cluster of deterministic streaming processors, and a simulation scheduler that mimics scheduling decisions of the scheduler. The capacity planner uses worst case load conditions and information about a number of the existing registered models to statically accept or reject the newly registered models.

### Example Computer System Architecture

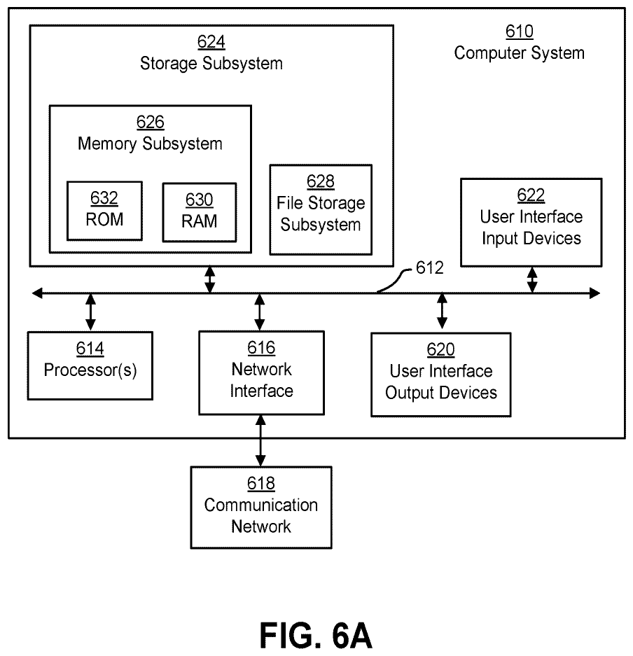

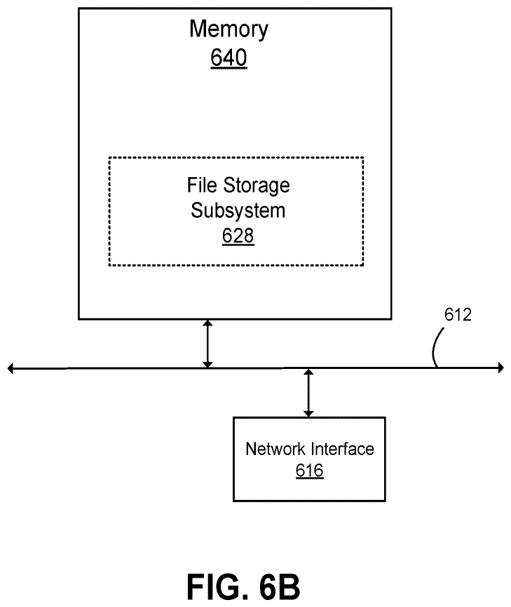

FIG. 6A is an abstract diagram of an example computer system suitable for enabling embodiments of the claimed disclosures, in accordance with some embodiments. In some embodiments described herein, a host processor comprises the computer system of FIG. 6A.

In FIG. 6A, the structure of computer system 610 typically includes multiple processors 614 which communicates with peripheral devices via bus subsystem 612. The deterministic cloud system 400 in FIG. 4A can be an embodiment of the computer system 610. TSPs in the TSP farm 420 can be embodiments of the processors 614. Typically, the computer includes a processor (e.g., a microprocessor, graphics processing unit, or digital signal processor), or its electronic processing equivalents, such as an ASIC or FPGA. Typically, peripheral devices include a storage subsystem 624, comprising a memory subsystem 626 and a file storage subsystem 628, user interface input devices 622, user interface output devices 620, and/or a network interface subsystem 616. The input and output devices enable direct and remote user interaction with computer system 610. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, for example, MICROSOFT WINDOWS, APPLE MACOS and IOS, GOOGLE ANDROID, Linux and/or Unix. The computer system typically includes a Basic Input/Output System (BIOS) and processor firmware. The operating system, BIOS and firmware are used by the processor to structure and control any subsystems and interfaces connected to the processor. Example processors that enable these operating systems include: the Pentium, Itanium, and Xeon processors from INTEL; the Opteron and Athlon processors from AMD (ADVANCED MICRO DEVICES); the Graviton processor from AMAZON; the POWER processor from IBM; the SPARC processor from ORACLE; and the ARM processor from ARM Holdings.

Any embodiment of the present disclosure is limited neither to an electronic digital logic computer structured with programs nor to an electronically programmable device. For example, the claimed embodiments can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 610 depicted in FIG. 6A is intended only as an example. Many other structures of computer system 610 have more components than the computer system depicted in FIG. 6A.

Network interface subsystem 616 provides an interface to outside networks, including an interface to communication network 618, and is coupled via communication network 618 to corresponding interface devices in other computer systems or machines. Communication network 618 can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 618 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or Integrated Services Digital Network (ISDN)), (asynchronous) digital subscriber line (DSL) unit, Firewire interface, universal serial bus (USB) interface, and the like. Communication algorithms (‘protocols’) can be specified using one or communication languages, such as Hypertext Transfer Protocol (HTTP), Transmission Control Protocol/Internet Protocol (TCP/IP), Real-time Transport Protocol/Real Time Streaming Protocol (RTP/RTSP), Internetwork Packet Exchange (IPX) protocol and/or User Datagram Protocol (UDP).

User interface input devices 622 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 610 or onto communication network 618. User interface input devices typically enable a user to select objects, icons, text and the like that appear on some types of user interface output devices, for example, a display subsystem.

User interface output devices 620 can include a display subsystem, a printer, a fax machine, or a non-visual communication device such as audio and haptic devices. The display subsystem can include a CRT, a flat-panel device such as an LCD, an image projection device, or some other device for creating visible stimuli such as a virtual reality system. The display subsystem can also provide non-visual stimuli such as via audio output, aroma generation, or tactile/haptic output (e.g., vibrations and forces) devices. Typically, the term ‘output device’ signifies all possible types of devices and processes to transfer data and information out of computer system 610 to the user or to another machine or computer system. Such devices are connected by wire or wirelessly to a computer system. Note that some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 626 typically includes several memories including a main RAM 630 (or other volatile storage device) for storage of instructions and data during program execution and a ROM 632 in which fixed instructions are stored. File storage subsystem 628 provides persistent storage for program and data files, and can include a hard disk drive, a floppy disk drive along with associated removable media, a CD-ROM drive, an optical drive, a flash memory such as a USB drive, or removable media cartridges. If computer system 610 includes an input device that performs optical character recognition, then text and symbols printed on a physical object (such as paper) can be used as a device for storage of program and data files. The databases and modules used by some embodiments can be stored by file storage subsystem 628.

Bus subsystem 612 provides a device for transmitting data and information between the various components and subsystems of computer system 610. Although bus subsystem 612 is depicted as a single bus, alternative embodiments of the bus subsystem can use multiple buses. For example, a main memory using RAM can communicate directly with file storage systems using DMA systems.

FIG. 6B is another abstract diagram of a computer system suitable for enabling embodiments of the claimed disclosures, in accordance with some embodiments. In some embodiments described herein, a host processor comprises the computer system of FIG. 6B.

FIG. 6B depicts a memory 640 such as a non-transitory, processor readable data and information storage medium associated with file storage subsystem 628, and/or with network interface subsystem 616 (e.g., via bus subsystem 612), and can include a data structure specifying a circuit design. The memory 640 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

One skilled in the art will recognize that any of the computer systems illustrated in FIGS. 6A-6B comprises a machine for performing a process that achieves an intended result by managing work performed by controlled electron movement.

### Additional Example Computing System

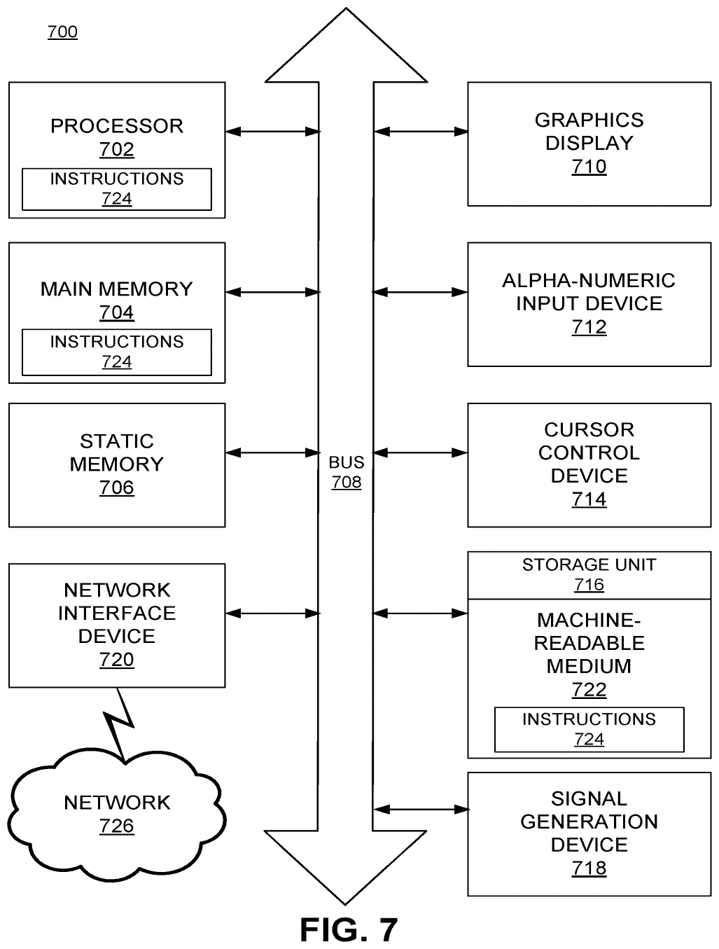

FIG. 7 is a block diagram illustrating components of an example computing machine that is capable of reading instructions from a computer-readable medium and executing them in a processor (or controller) according to an embodiment. A computer described herein includes a single computing machine shown in FIG. 7, a virtual machine, a distributed computing system that includes multiple nodes of computing machines shown in FIG. 7, or any other suitable arrangement of computing devices. The computer described herein can be used by any of the elements described in the previous figures to execute the described functions.

By way of example, FIG. 7 depicts a diagrammatic representation of a computing machine in the example form of a computer system 700 within which instructions 724 (e.g., software, program code, or machine code), which can be stored in a computer-readable medium, causing the machine to perform any one or more of the processes discussed herein. In some embodiments, the computing machine operates as a standalone device or is connected (e.g., networked) to other machines. In a networked deployment, the machine operates in the capacity of a server machine or a client machine in a server-client network environment, or as a peer machine in a peer-to-peer (or distributed) network environment.

The structure of a computing machine described in FIG. 7 corresponds to any software, hardware, or combined components shown in the figures above. By way of example, a computing machine is a tensor streaming processor designed and manufactured by GROQ, INC. of Mountain View, California, a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 724 that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors (generally, a processor 702) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 further includes graphics display unit 710 (e.g., a plasma display panel (PDP), a liquid crystal display (LCD), a projector, or a cathode ray tube (CRT)). The computer system 700 can also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a computer-readable medium 722 on which the instructions 724 are stored embodying any one or more of the methodologies or functions described herein. The instructions 724 can also reside, completely or at least partially, within the main memory 704 or within the processor 702 (e.g., within a processor's cache memory). Thus, during execution thereof by the computer system 700, the main memory 704 and the processor 702 can also constitute computer-readable media. The instructions 724 can be transmitted or received over a network 726 via the network interface device 720.

While the computer-readable medium 722 is shown in an example embodiment to be a single medium, the term “computer-readable medium” should be taken to include a single medium or multiple media (e.g., a centralized or distributed database, or associated caches and servers) able to store instructions (e.g., the instructions 724). The computer-readable medium 722 includes any medium that is capable of storing instructions (e.g., the instructions 724) for execution by the machine and that cause the machine to perform any one or more of the methodologies disclosed herein. The computer-readable medium 722 can include, but not be limited to, data repositories in the form of solid-state memories, optical media, and magnetic media. The computer-readable medium 722 does not include a transitory medium such as a signal or a carrier wave.

### Additional Considerations

The disclosed configurations have benefits and advantages that include, for example, a more efficient data flow by separating the functions of the processor into specialized functional units, and configuring the timing of data and instructions to each functional unit, such that each unit is able operate on received data based upon a known timing between received data and instructions. Because the compiler for the processor is hardware aware, it is able to configure an explicit plan for the processor indicating how and when instructions and data operands are transmitted to different tiles of the processor. By accounting for the timing of received instructions and data, the data can be transmitted between the tiles of the processor without unnecessary metadata, increasing the efficiency of the transmission. In addition, by separating the transmission of data and instructions, instructions can be iterated and looped independent of received data operands.

In addition, because each computational element of the processor is dedicated to a specific function (e.g., MEM, VXM, MXM, SXM), the amount of instructions needed to be processed by the computational elements can be reduced. For example, certain computational elements (e.g., in MXM functional slice) can be configured to perform a limited set of operations on any received data. As such, these computational elements can operate without having to receive explicit instructions or only receiving intermittent or limited instructions, potentially simplifying operation of the processor. For example, data operands read from memory can be intercepted by multiple functional slices as the data is transmitted across a data lane, allowing for multiple operations to be performed on the data in a more efficient manner.

In operation, a host computer programs a DMA engine to actually transfer data, again all of which is coordinated by the runtime layer. Specifically, the IDU transfers 320-byte vectors from PCIe-Gen4 32-bytes every core-clock cycle (e.g., nominal 900 Mhz). Thus, the 320-element vector arrives over a period of 10 cycles and placed on multiple streams moving towards the MEM. The incoming streams flow on S24-31 (upper eight streams), from which the MEM performs a “write” to commit that vector to SRAM. Hence, a PCI-Receive consists of (i) receiving the data from the PCI interface, and (ii) writing the vector into the specified functional slice of the MEM.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules can be embodied in software, firmware, hardware, or any combinations thereof.

Any of the steps, operations, or processes described herein can be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure can also relate to an apparatus for performing the operations herein. This apparatus can be specially constructed for the required purposes, and/or it can comprise a general-purpose computing device selectively activated or reconfigured by a computer program stored in the computer. Such a computer program can be stored in a non-transitory, tangible computer readable storage medium, or any type of media suitable for storing electronic instructions, which is coupled to a computer system bus. Furthermore, any computing systems referred to in the specification can include a single processor or can be architectures employing multiple processor designs for increased computing capability.

Some embodiments of the present disclosure can further relate to a system comprising a processor (e.g., a tensor streaming processor or an artificial intelligence processor), at least one computer processor (e.g., a host server), and a non-transitory computer-readable storage medium. The storage medium can store computer executable instructions, which when executed by the compiler operating on the at least one computer processor, cause the at least one computer processor to be operable for performing the operations and techniques described herein.

Finally, the language used in the specification has been principally selected for readability and instructional purposes, and it has not been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A computing system comprising:
a plurality of deterministic processors each configured to execute one or more assembled programs in a program order of the one or more assembled programs; and
a plurality of communication links providing communication between pairs of processors of the plurality of deterministic processors.

2. The computing system of claim 1, wherein each of the plurality of deterministic processors comprises one or more static random-access memory (SRAM) units.

3. The computing system of claim 1, further comprising a plurality of dynamic random-access memory (DRAM) units.

4. The computing system of claim 3, wherein at least one deterministic processor of the plurality of deterministic processors computes directly from at least one DRAM unit of the plurality of DRAM units without a cache hierarchy.

5. The computing system of claim 4, wherein the at least one deterministic processor can access two or more DRAM units of the plurality of DRAM units using a memory space that is globally addressable by the at least one deterministic processor independent of which of the two or more DRAM units contains data to be accessed.

6. The computing system of claim 1, wherein each deterministic processor of the plurality of deterministic processors is configured to perform deterministic memory access.

7. The computing system of claim 1, further comprising a compiler configured to generate the one or more assembled programs, wherein the compiler has explicit control of the program order of the one or more assembled programs.

8. The computing system of claim 7, further comprising a plurality of memory units, and wherein the compiler is configured to allocate memory for a plurality of concurrent operands to a plurality of separate memory units to facilitate data concurrency.

9. The computing system of claim 7, wherein the compiler is configured to synchronize timing of data and instruction flows to cause a first data item and a first instruction to arrive at a first computational element of the plurality of deterministic processors with a predetermined temporal relationship.

10. The computing system of claim 7, further comprising a scheduler configured to assign one or more workloads to one or more subsets of the plurality of deterministic processors.

11. The computing system of claim 10, wherein the scheduler is configured to assign the one or more workloads based at least in part on deterministic timing data associated with the one or more workloads.

12. The computing system of claim 10, wherein the scheduler is configured to assign the one or more workloads based at least in part on one or more of:
a comparison between a first memory capacity of one or more first processors of the plurality of deterministic processors and a second memory capacity of one or more second processors the plurality of deterministic processors; and
a comparison between a first number of arithmetic operations per second that can be performed by the one or more first processors and a second number of arithmetic operations per second that can be performed by the one or more second processors.

13. The computing system of claim 10, wherein the scheduler is configured to select one or more operating parameters of the one or more workloads based at least in part on deterministic timing data associated with the one or more workloads.

14. The computing system of claim 10, wherein the scheduler is configured to select one or more operating parameters of the one or more workloads based at least in part on power usage data associated with the one or more workloads.

15. The computing system of claim 14, wherein the power usage data comprises power budget data.

16. The computing system of claim 10, wherein the compiler is configured to compile a first portion of a machine learning operation to generate an intermediate representation; and compile, based at least in part on one or more operating parameter selections or processor assignments determined by the scheduler, a second portion of the machine learning operation, wherein the first portion is compiled independently of the one or more operating parameter selections or processor assignments.

17. The computing system of claim 10, wherein the compiler is configured to generate the one or more assembled programs based at least in part on data indicative of a machine-learned model.

18. The computing system of claim 1, further comprising one or more peripheral component interconnect express (PCIe) connections.

19. A method comprising:
compiling, by a compiler, a machine-learned model to generate one or more assembled programs, wherein configured to explicitly control a program order of the one or more assembled programs; and
assigning, by a scheduler, the one or more assembled programs to a subset of a plurality of deterministic processors each configured to execute instructions according to the program order of the one or more assembled programs.

20. One or more non-transitory computer-readable media storing instructions that are executable by one or more processors to cause a computing system to perform operations, the operations comprising:
compiling, by a compiler, a machine-learned model to generate one or more assembled programs, wherein configured to explicitly control a program order of the one or more assembled programs; and
assigning, by a scheduler, the one or more assembled programs to a subset of a plurality of deterministic processors each configured to execute instructions according to the program order of the one or more assembled programs.
